(19) United States
(12) Patent Application Publication
(10) Pub. No.: US 2025/0255215 A1
(43) Pub. Date: Aug. 14, 2025

(54) REARWARD SIDE DISCHARGE MOW DECK AND DECK INSERTS FOR BAGGING AND SIDE DISCHARGE

(71) Applicant: MTD PRODUCTS INC, Valley City, OH (US)

(72) Inventors: Jay Maggard, Polk, OH (US); Axel Schaedler, Olmsted Falls, OH (US)

(21) Appl. No.: 19/048,266

(22) Filed: Feb. 7, 2025

Related U.S. Application Data
(60) Provisional application No. 63/551,787, filed on Feb. 9, 2024.

(51) Int. Cl. A01D 34/71; A01D 34/66; A01D 101/00

(52) U.S. Cl. CPC A01D 34/71; A01D 34/667; A01D 2101/00

(57) ABSTRACT

Various embodiments comprise rearward discharge housings and lawn maintenance apparatuses comprising or employing such rearward discharge housings. One example embodiment is a rearward discharge housing, comprising: an intake interface that defines a first opening in the housing and is configured to couple with a discharge port of the mow deck, wherein the intake interface is configured to receive material from the mow deck at a first horizontal angle that is at least 55° away from a rear direction relative to the mow deck; an inner surface configured to redirect material received via the intake interface to a second horizontal angle that is within 45° of the rear direction; and an output configured to expel the material from the housing.

### CROSS-REFERENCE TO RELATED APPLICATION

The present application for patent claims the benefit of priority from U.S. Provisional Application No. 63/551,787 filed Feb. 9, 2024 and titled REARWARD SIDE DISCHARGE MOW DECK AND DECK INSERTS FOR BAGGING AND SIDE DISCHARGE, which is hereby incorporated by reference herein in its entirety and for all purposes.

### FIELD OF DISCLOSURE

The disclosed subject matter pertains to apparatuses and methods for an outdoor power equipment, for instance, systems and apparatuses for redirecting and/or bagging material from the outdoor power equipment, such as turf clippings from a mowing implement of a turf maintenance machine.

### BACKGROUND

Manufacturers of power equipment for outdoor maintenance applications offer many types of machines for general maintenance and mowing applications. These machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Modern maintenance machines also offer multiple options for a power source. The various advantages associated with electric motor engines, gasoline engines, natural gas engines, diesel engines and so forth also impact the mechanical design and engineering that go into these different maintenance devices. Meeting the various challenges associated with different maintenance and mowing applications and the benefits and limitations of different power sources results in a large variety of maintenance machines to meet consumer preferences.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Embodiments of the present disclosure provide a rearward directed side discharge housing or rearward discharge housing, as well as lawn maintenance apparatuses comprising or employing such discharge housings. Rearward discharge housings discussed herein can redirected material from a mow deck to a bagging system, etc., while retaining substantially more kinetic energy in the material than existing discharge apparatuses (e.g., side discharge, etc.).

In one or more embodiments, disclosed is an apparatus, comprising: an intake interface that defines a first opening in the apparatus and is configured to couple with a discharge port of a mow deck of a mowing machine, wherein the intake interface is configured to receive material from the mow deck at a first horizontal angle that is at least 55° away from a rear direction relative to the mow deck; an inner surface configured to redirect material received via the intake interface to a second horizontal angle that is within 45° of the rear direction; and an output configured to expel the material from the apparatus.

In further embodiments, disclosed is a lawn maintenance apparatus, comprising: a frame; a mow deck attached to the frame; and a rearward discharge housing, comprising: an intake interface that defines a first opening in the housing and is configured to couple with a discharge port of the mow deck, wherein the intake interface is configured to receive material from the mow deck at a first horizontal angle that is at least 55° away from a rear direction relative to the mow deck; an inner surface configured to redirect material received via the intake interface to a second horizontal angle that is within 45° of the rear direction; and an output configured to expel the material from the housing.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIGS. 1A and 1B depict a mow deck with a side discharge opening in connection with various embodiments.

FIGS. 2A and 2B illustrate a mow deck with a first example embodiment of a rearward-directed discharge opening according to various embodiments.

FIG. 3 depicts a mow deck with a detachable front-edge baffle for implementing a second example embodiment of a rearward-directed discharge opening according to yet other aspects of the disclosure.

FIG. 4 illustrates a mow deck with a detachable front-edge baffle and third example embodiment according to still further aspects disclosed herein.

FIG. 5 illustrates a photograph of a prototype embodiment of a mow deck with a rearward side discharge, according to various aspects discussed herein.

FIG. 6 illustrates four photographs of a prototype embodiment of a mow deck with a rearward side discharge illustrating the separation between the mow blade and discharge housing at various angles, according to various aspects discussed herein.

FIG. 7 illustrates an inside perspective view of a fourth example housing, according to various aspects discussed herein.

FIG. 8 illustrates a top view of the fourth example housing, according to various aspects discussed herein.

FIG. 9 illustrates a bottom view of the fourth example housing, according to various aspects discussed herein.

FIG. 10 illustrates an outside view of the fourth example housing, according to various aspects discussed herein.

FIG. 11 illustrates an outside perspective view of the fourth example baffle, according to various aspects discussed herein.

FIG. 12 illustrates a photograph of an example prototype of the fourth example embodiment, according to various aspects discussed herein.

FIG. 13 illustrates photographs showing a top view (top image) and outside view (bottom image) of a prototype of a fifth example embodiment of a rearward side discharge, according to various aspects discussed herein.

FIG. 14 illustrates a photograph of an interior of the prototype of the fifth example embodiment of a rearward discharge housing according to various aspects discussed herein.

FIG. 15 illustrates three photographs of a prototype of a sixth example embodiment of a rearward side discharge, according to various aspects discussed herein.

FIG. 16 illustrates an inside view (top) and an inside perspective view (bottom) of a seventh example embodiment of a rearward discharge housing, according to various aspects discussed herein.

FIG. 17 illustrates a rear view (left) and an elevated rear view (right) of the seventh example embodiment of a rearward discharge housing, according to various aspects discussed herein.

FIG. 18 illustrates an outside view (top) and a front view (bottom) of the seventh example embodiment of a rearward discharge housing, according to various aspects discussed herein.

FIG. 19 illustrates a top view (top) and a bottom view (bottom) of the seventh example embodiment of a rearward discharge housing, according to various aspects discussed herein.

FIG. 20 illustrates an inside view (top) and an inside perspective view (bottom) of the eighth example embodiment of a rearward discharge housing, according to various aspects discussed herein.

FIG. 21 illustrates a rear view (left) and an elevated rear view (right) of the eighth example embodiment of a rearward discharge housing, according to various aspects discussed herein.

FIG. 22 illustrates an outside view (top) and a front view (bottom) of the eighth example embodiment of a rearward discharge housing, according to various aspects discussed herein.

FIG. 23 illustrates a top view (top) and a bottom view (bottom) of the eighth example embodiment of a rearward discharge housing, according to various aspects discussed herein.

FIG. 24 depicts a rear edge of an ejection port of a mow deck coupled to a rear edge of a rearward discharge intake in one or more additional aspects of the disclosure.

FIG. 25 illustrates a top view of rear surfaces of an example rearward discharge intake including a discharge surface and recirculation surface in further aspects of the disclosure.

FIG. 26 depicts a side interior view of the rearward discharge intake and the recirculation surface thereof, in an aspect(s).

FIG. 27 illustrates a bottom interior view of the rearward discharge intake and an interface of the recirculation surface and rear interior surface of a mow deck in other aspects.

FIG. 28 depicts a front perspective interior view of the rearward discharge intake in still further aspects of the present disclosure.

FIG. 29 illustrates a front interior view of the rearward discharge intake in one or more additional aspects of the present disclosure.

FIG. 30 illustrates an image of interior surfaces of an rearward discharge intake coupled to a discharge port of a mow deck, according to further disclosed aspects.

FIG. 31 illustrates an example baffle structure within an interior of a mow deck usable in conjunction with the intake structure of FIG. 30, in further aspects of the disclosure.

FIG. 32 depicts an underside view of the baffle structure of FIG. 31.

FIG. 33 illustrates left perspective (top) and right (bottom) views of an example embodiment of a lawn maintenance apparatus in a seated configuration, according to various aspects discussed herein.

FIG. 34 illustrates top (top) and front (bottom) views of the example embodiment in the seated configuration, according to various aspects discussed herein.

FIG. 35 illustrates rear (top) and left (bottom) views of the example embodiment in the seated configuration, according to various aspects discussed herein.

FIG. 36 illustrates left perspective (top) and right (bottom) views of the example embodiment in a standing configuration, according to various aspects discussed herein.

FIG. 37 illustrates top (top) and front (bottom) views of the example embodiment in the standing configuration, according to various aspects discussed herein.

FIG. 38 illustrates rear (top) and left (bottom) views of the example embodiment in the standing configuration, according to various aspects discussed herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to transporting turf clippings from a mow deck of power equipment machines are described herein, it should be understood that the disclosed machines, electronic and computing devices and methods are not so limited and modifications may be made without departing from the scope of the present disclosure. The scope of the devices, components of such devices, coupling apparatuses and power sources are defined by the appended claims, and all devices, components, and apparatuses that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” “turf maintenance machine” and “power equipment machine” are used interchangeably and are intended to refer to any of robotic, partially robotic ride-on, manually operated ride-on, walk-behind, sulky equipped, autonomous, semi-autonomous (e.g., user-assisted automation), remote control, or multi-function variants of any of the following: powered carts and wheel barrows, motorized or non-motorized trailers, lawn mowers, lawn and garden tractors, cars, trucks, go-karts, scooters, buggies, powered four-wheel riding devices, powered three-wheel riding devices, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

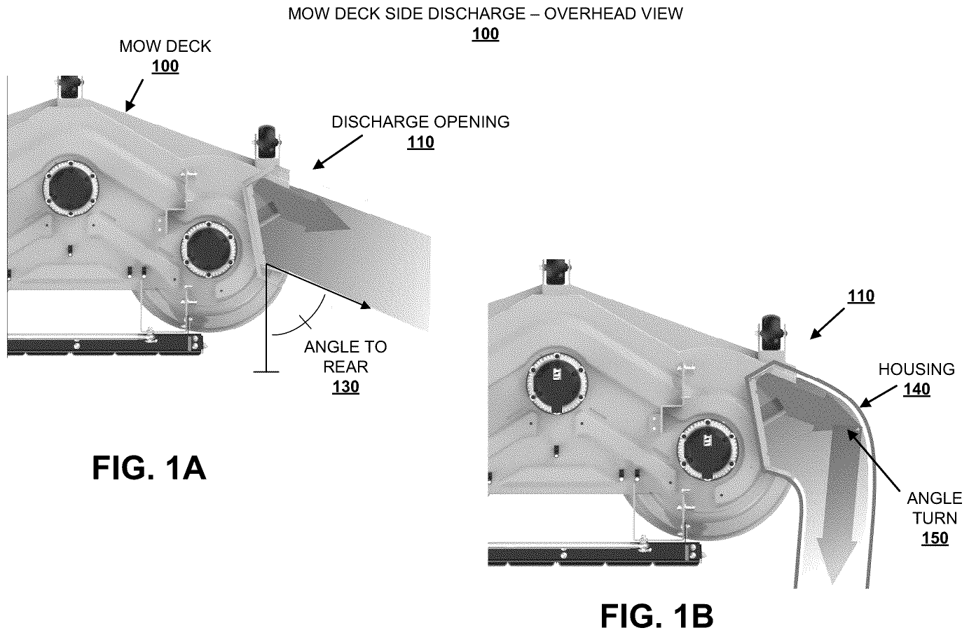

As utilized herein, terms of degree such as approximately, substantially, about, roughly and so forth, are intended to incorporate ranges and variations about a qualified term reasonably encountered by one of ordinary skill in the art in fabricating or compiling the embodiments disclosed herein, where not explicitly specified otherwise. For instance, a term of degree can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, terms of degree can refer to a variation in a disclosed value or characteristic; e.g., a zero to five-percent variance or a zero to ten-percent variance from precise mathematically defined value or characteristic, or any suitable value or range there between can define a scope for a disclosed term of degree. As an example, a rear discharge angle (e.g., see FIGS. 1A and 1B, infra) can define an angle to a fixed direction (e.g., a rear direction; 180 degrees from a forward direction of travel; etc.) with a variance within reasonable manufacturing tolerances, a variance of zero to five-percent of a disclosed angle(s), a variance of 5-6 degrees or less of the disclosed angle(s), a variance of 2-3 degrees or less of the disclosed angle(s), or any suitable value or range there between. These or similar variances can be applicable to other contexts in which a term of degree is utilized herein such as timing of a computer-controlled signal, power applied by a motor onto a component of a disclosed maintenance apparatus, accuracy of measurement of a physical effect (e.g., a dimension, a torque output, an electric power consumption, etc.) or the like.

FIGS. 1A and 1B depict an overhead view of a mow deck 100 with side discharge, in connection with various embodiments of the present disclosure. Mow deck 100 can be a side discharge mow deck or a top discharge mow deck, or a suitable combination of the foregoing. Mow deck 100 includes a discharge opening from which turf clippings, leaves, vegetation, loose dirt and other material can be expelled during operation of a cutting unit beneath mow deck 100. As is shown at FIG. 1A, discharge opening 110 defines an angle to rear 130 suitable to distribute turf clippings and other material in a relatively uniform distribution out a lateral direction from mow deck 100 through discharge opening 110. In an embodiment, angle to rear 130 can be in a range from about 55 degrees to about 75 degrees from a rearward direction as shown, or any suitable value or range there between.

FIG. 1B illustrates an outline of a housing 140 coupled to discharge opening 110 and configured to capture turf clippings and other material expelled from discharge opening 110 therein. Housing 140 can comprise a disclosed conveyor apparatus in various embodiments, including a conveyor/deck interface immediately adjacent to (and in fluid communication with) discharge opening 110 such that material expelled from discharge opening 110 can be received by a bagging system (e.g., passive bagging or active bagging, such as assisted by a blower or any other powered system that assists or facilitates movement of material in connection with a bagging system, etc.) through discharge opening 110, as described herein. A curved interior surface can redirect material moving in a direction shown by angle to rear 130 further rearward as shown at angle turn 150. The angle turn 150 can slow down the momentum of the material, potentially causing a backup of material within housing 140 at angle turn 150 in the event of very high volumes of material, high density of material, wet material, or the like entering housing 140.

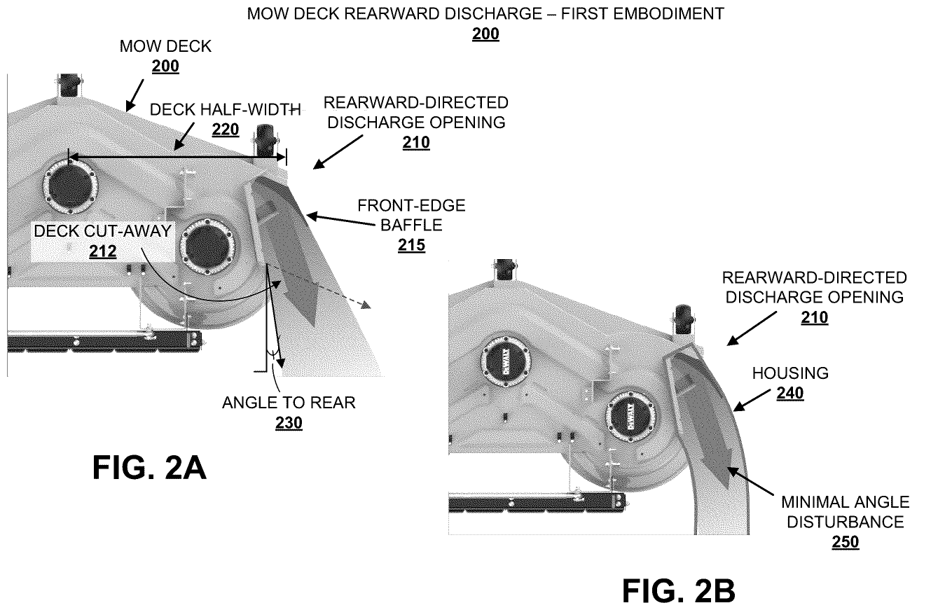

FIGS. 2A and 2B disclose a drawing of a first example embodiment of a rearward directed discharge for a mow deck 200 according to various embodiments of the present disclosure. Referring to FIG. 2A, mow deck 200 has a rearward directed side discharge opening 210. Rearward directed discharge opening 210 has an angle to rear 230 smaller than angle to rear 130 of FIGS. 1A and 1B. In various embodiments, rearward directed discharge housing can have an inner surface around 0.25 in. away from the tips of mow blades (e.g., 0.125-0.375 in., etc.) throughout a front portion of the inner surface, which can have a shape substantially the same as the arc of a circle centered around the center of rotation of the mow blades, until departing from the circular arc at an angle above horizontal in FIGS. 2A and 2B equal to around the angle to rear 230, behind which the inner surface can be substantially straight, piecewise straight, curved at a greater radius of curvature, etc.

In various embodiments, rearward-directed discharge opening 210 can be implemented with a front-edge baffle 215 that contains turf clippings and material driven within mow deck 200 by a cutting unit along a further arc than discharge opening 110 of mow deck 100, as shown by the shaded arrow within rearward-directed discharge opening 210. Front-edge baffle 215 can maintain contact between the cutting unit (e.g., edge of a blade) and turf clippings and other material until front-edge baffle ends and the material exits rearward-directed discharge opening 210. This causes the material to maintain energy provided by the cutting unit until the material exits the discharge opening. The location of rearward directed side discharge opening 210 in mow deck 200 can be similar (or identical, depending on the embodiment) to that of side discharge opening 110 in mow deck 100, but the use of front-edge baffle 215 or similar redirection surface(s) (e.g., a piecewise approximation of the curve of front-edge baffle 215, etc.) can provide for more efficient movement of material to the rear of a vehicle employing rearward-directed discharge opening 210 (and similarly with other embodiments discussed herein).

Additionally, rearward-directed discharge opening 210 can optionally be implemented with a deck cut-away 212 that removes a section of mow deck 200 and opens a rearward arc of the mow deck 200. The rearward arc opened by deck cut-away 212 is shown between the gray dotted line and the new rear opening in rearward-directed discharge opening 210 as shown in FIG. 2A. In an embodiment, angle to rear 230 can be less than thirty degrees. In another embodiment, angle to rear 230 can be in a range from about ten to about thirty degrees, or any suitable value or range there between (e.g., 10, 12, 15, 17, 20, 24, 28, 30 degrees, etc., or 10 to 15, 12 to 17, 15 to 20, 20 to 25, 23 to 28 degrees, and so forth).

As shown in FIG. 2B, a housing 240 can be secured to mow deck 200 covering rearward-directed discharge opening 210 and optionally covering front-edge baffle 215. Housing 240 receives turf material output from rearward-directed discharge opening 210 with minimal angle disturbance 250 together with directing the turf material toward a rear of housing 240. This significantly improves retention of momentum and kinetic energy of the turf material as it transitions from mow deck 200 into and through housing 240, optimizing energy efficiency associated with transferring turf material into and through housing 240 (e.g., to a passive or active bagging system). By maintaining a substantially greater portion of the kinetic energy of material entering housing 240 in material exiting housing 240, passive bagging (e.g., wherein material moves through a tube, etc. to a bagging system based on its momentum, etc.) can be enabled in scenarios not possible with existing discharge systems and/or apparatuses, and active bagging systems can operate with substantially less energy than in connection with existing discharge systems and/or apparatuses. This energy savings can provide increased runtime for battery-powered lawn maintenance equipment.

Various embodiments can be or comprise a rearward discharge housing with any of a variety of aspects or features discussed herein, which can receive material from a mow deck via a discharge opening, intake interface, or input to the discharge housing and expel the material via a second opening or output near the rear of the discharge housing. Material received via the discharge opening can be received at a first angle (e.g., substantially equal to angle to rear 130, 55° or greater from the rear direction relative to the mow deck, etc.) and redirected to be discharged via the second opening at a second angle (e.g., such as angle to rear 230, or any angle 45° or less from the rear direction relative to the mow deck, etc.). In contrast to the side discharge of FIGS. 1A-1B, rearward directed discharge housings discussed herein can redirect material through a more gradual and smoother transition that maintains a significantly greater portion of the kinetic energy of the material.

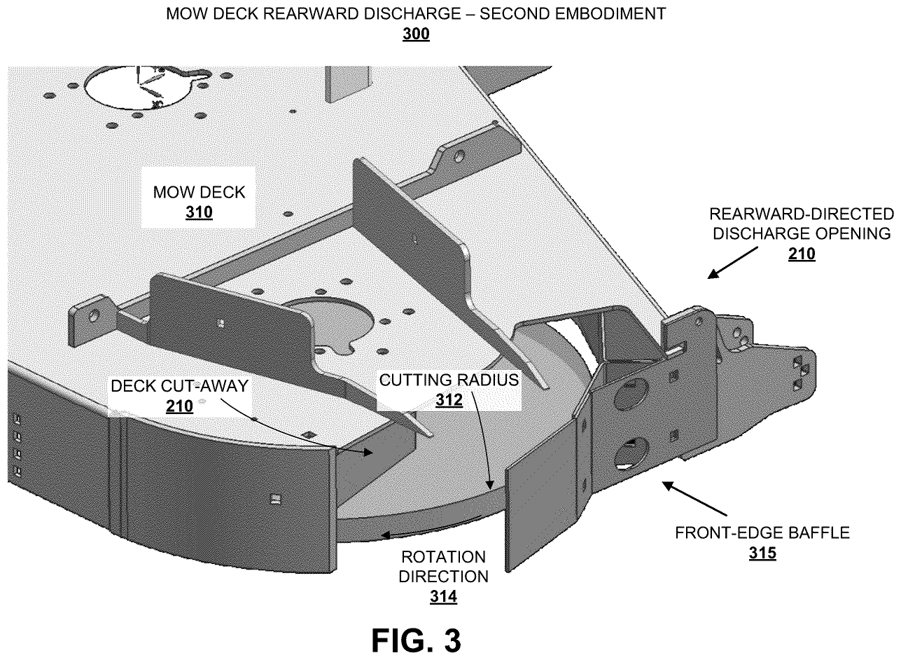

FIG. 3 depicts a perspective view 300 of a mow deck 310 according to a second example embodiment of the present disclosure. Mow deck 310 defines a rearward-directed discharge opening 210 in mow deck 310. A cutting radius 312 of a cutting unit secured to mow deck 310 provides kinetic energy to loose material within mow deck 310. Front-edge baffle 315 extends an exterior wall around an arc of cutting radius 312 beyond an opening defined in mow deck 310 by rearward-directed discharge opening 210. The loose material maintains the kinetic energy until the extended wall of front-edge baffle 315 is exceeded in rotation direction 314. A deck cut-away portion 210 maintains the opening following the extended exterior wall provided by front-edge baffle 315 up to an angle to rear 230 as shown in FIGS. 2A and 2B, supra.

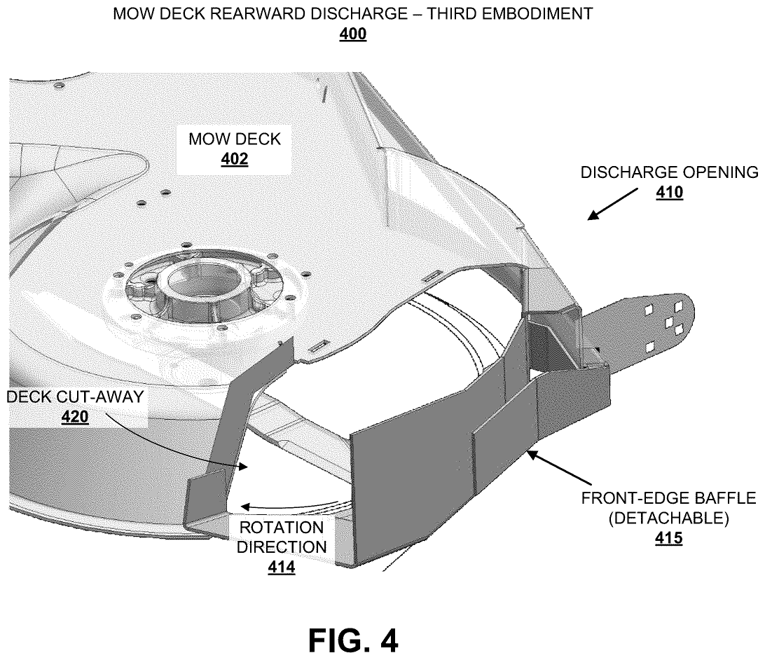

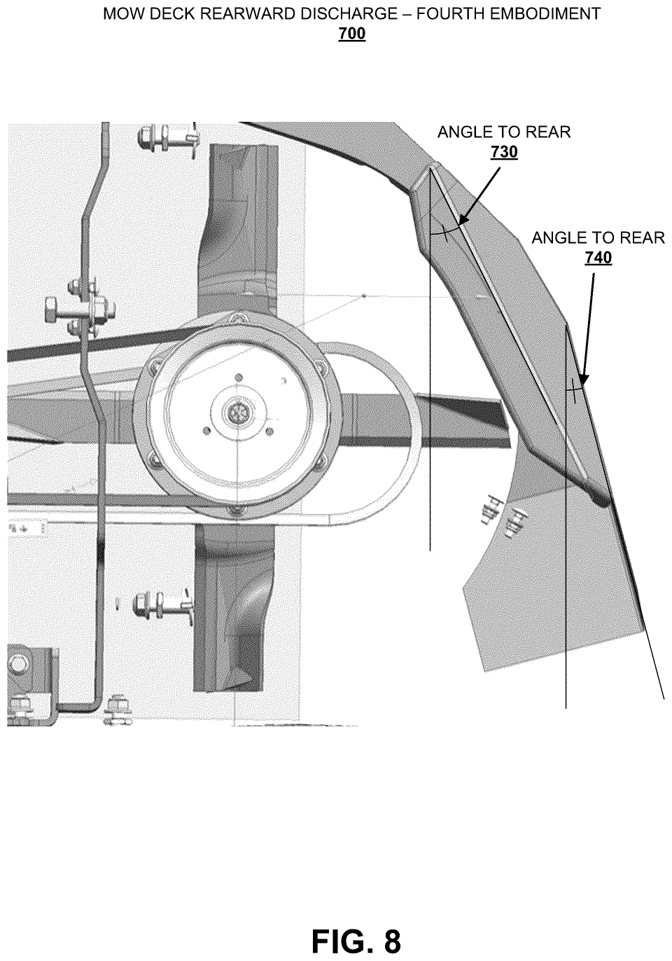

FIG. 4 depicts an alternative baffle 400 for a rearward discharge mow deck according to a third example embodiment of the present disclosure. Mow deck 402 defines a discharge opening 410, including a deck cut-away 420 opening the discharge opening to an angle to rear similar to angle to rear 230 as shown in FIGS. 8A and 8B. A front-edge baffle 415 is shown that is removably attachable to mow deck 402 to extend an arc of a perimeter of mow deck 402 through discharge opening 410 in rotation direction 414 toward the deck cut-away portion 420. Front-edge baffle 415 can be attached to mow deck 402 as shown to implement rearward-directed discharge into a passive or active bagging system to implement a bagging mode for mow deck 402.

For a side-discharge mode, front-edge baffle 415 can be removed and a side-discharge chute can be inserted into discharge opening 410. In one or more embodiments, side-discharge chute can have a deck cut-away material attached, formed, molded or otherwise integral to the side-discharge chute. The deck cut-away material can restore a portion of a rear of mow deck 402 removed as shown in FIG. 2A (dotted gray arrow) compared with FIG. 1A. Stated differently, the deck cut-away material can restore the mow deck discharge opening to have angle to rear 130 as shown in FIG. 1A, to implement the side-discharge mode.

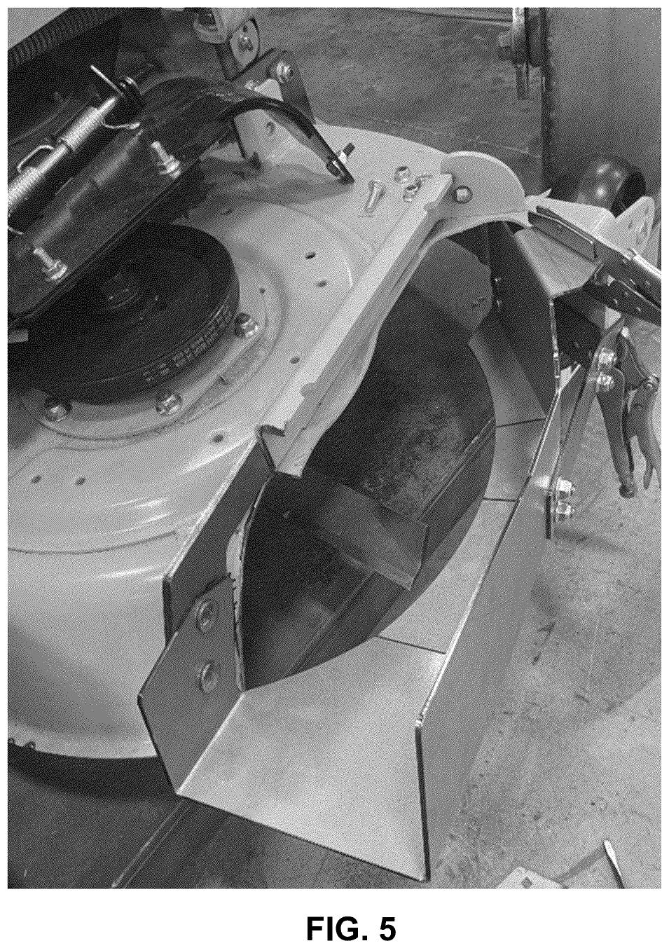

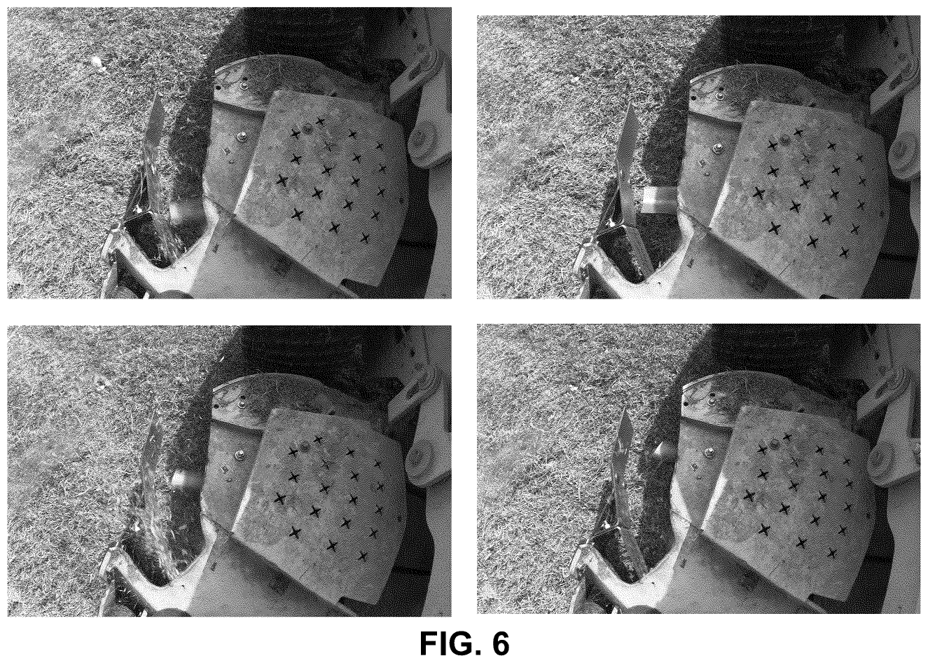

Referring to FIG. 5, illustrated is a photograph of a prototype embodiment of a mow deck with a rearward side discharge similar to the first, second, and third example embodiments. FIG. 6 shows four photographs of a prototype embodiment of a mow deck with a rearward side discharge illustrating the separation between the mow blade and discharge housing at various angles. As can be seen in FIG. 6, the separation between the mow blade and discharge housing remains close in the top two images but increases in the bottom two images.

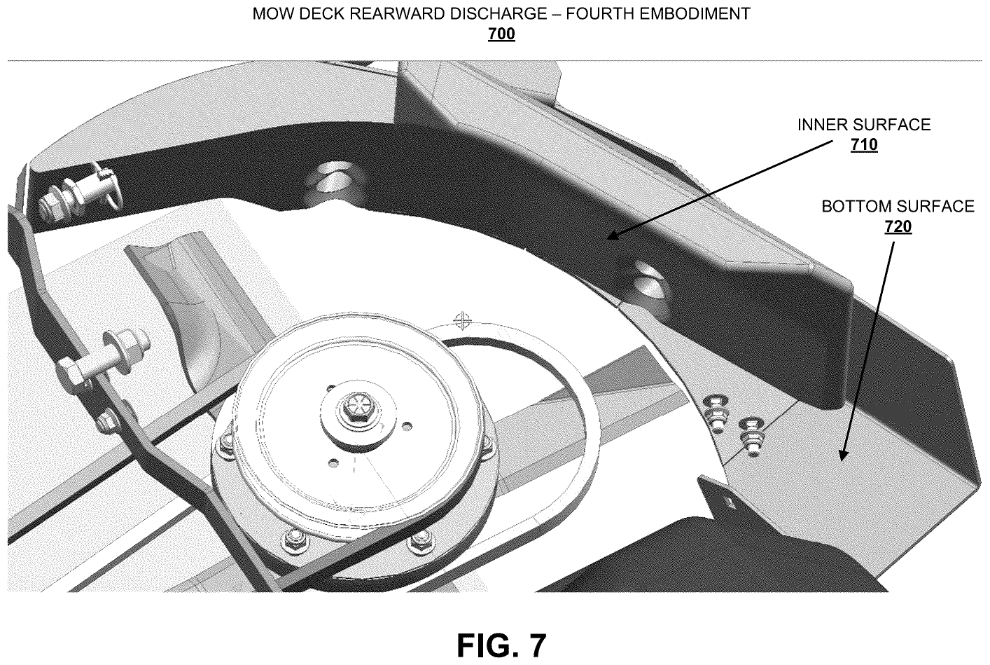

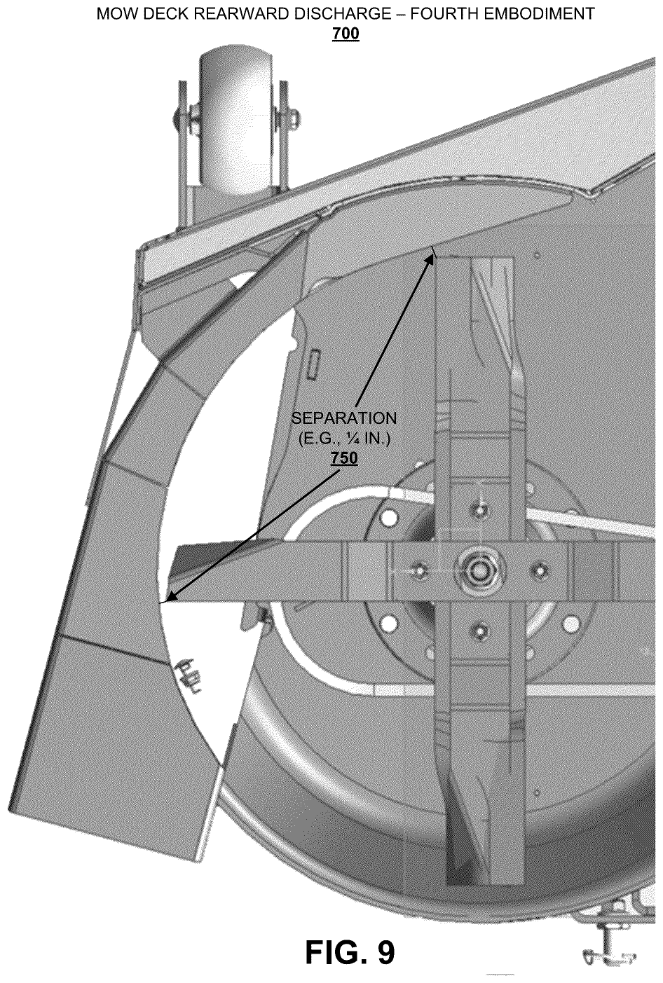

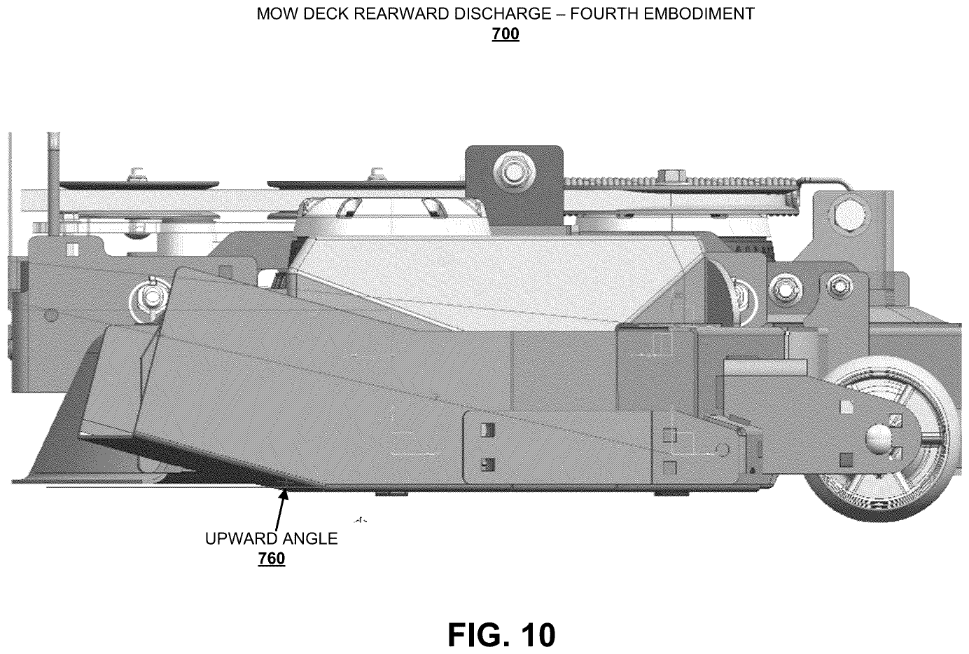

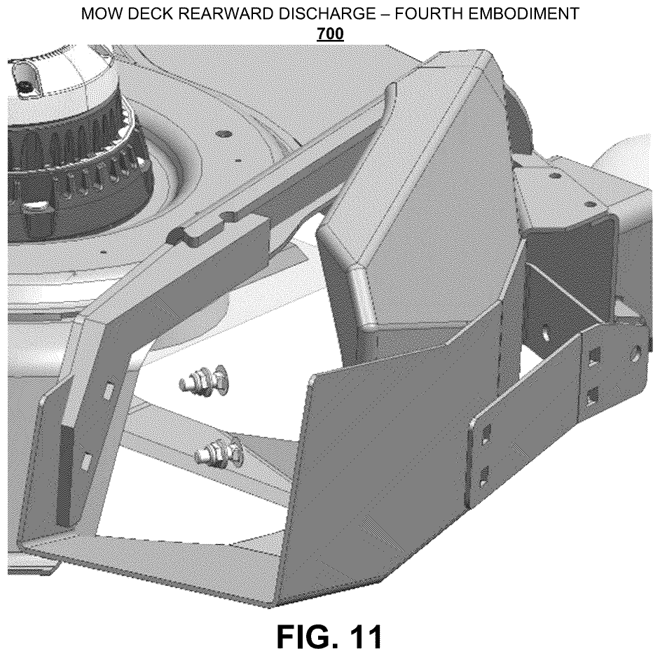

FIGS. 7-11 show various views of a fourth example embodiment of a rearward discharge housing 700. Referring to FIG. 7, illustrated is an inside perspective view of the fourth example housing 700, according to various aspects discussed herein. Referring to FIG. 8, illustrated is a top view of the fourth example housing 700, according to various aspects discussed herein. Referring to FIG. 9, illustrated is a bottom view of the fourth example housing 700, according to various aspects discussed herein. Referring to FIG. 10, illustrated is an outside view of the fourth example housing 700, according to various aspects discussed herein. Referring to FIG. 11, illustrated is an outside perspective view of the fourth example baffle 700, according to various aspects discussed herein.

Housing 700 comprises a curved inner surface that maintains a substantially constant separation 750 (e.g., 0.125-0.375 in or any range or value therein, such as around 0.25 in, etc.) from the tips of the adjacent mow blades through an arc (defined by a front portion of inner surface 710) from a front of housing 700 until a straight portion of inner surface 710 (near the front end of bottom surface 720), which can have an angle to rear 730 of 20-30° or any range or value therein, such as around 26-28°, around 27°, etc. The relatively small separation 750 can maintain the kinetic energy of material (e.g., turf clippings, etc.) as they are directed from mow blades through housing 700 to angle to rear 730, reducing energy loss caused by redirections such as angle turn 150 of FIG. 1 and similar features of existing side discharge mow decks.

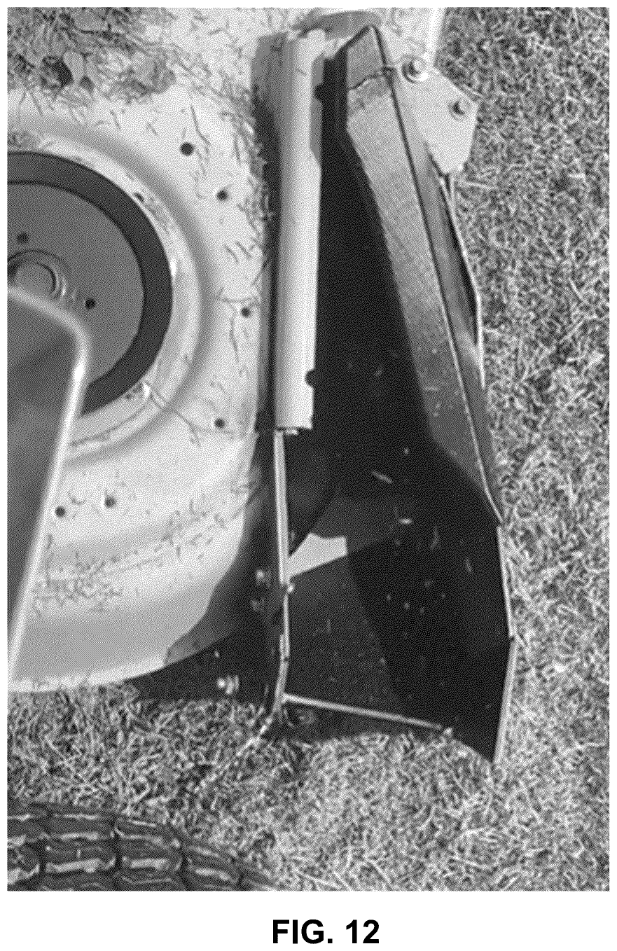

Material passing beyond inner surface 710 can be further redirected by bottom surface 720 rearward (e.g., via a surface with angle to rear 740, which can be 10-20° or any range or value therein, such as around 14-16°, around 15°, etc.) and/or upward by both the kinetic energy of the material and the upward angle 760 (e.g., 10-20° or any range or value therein, such as around 14-16°, around 15°, etc.) of bottom surface 720 into a range of trajectories (e.g., ranging from upward angle 760 to around 45° or greater, etc.). Additionally, as can be seen in FIG. 11, a top edge of inner surface 710 of housing 700 slopes inward over a portion of bottom surface 720. Referring to FIG. 12, illustrated is a photograph of an example prototype of the fourth example embodiment, according to various aspects discussed herein.

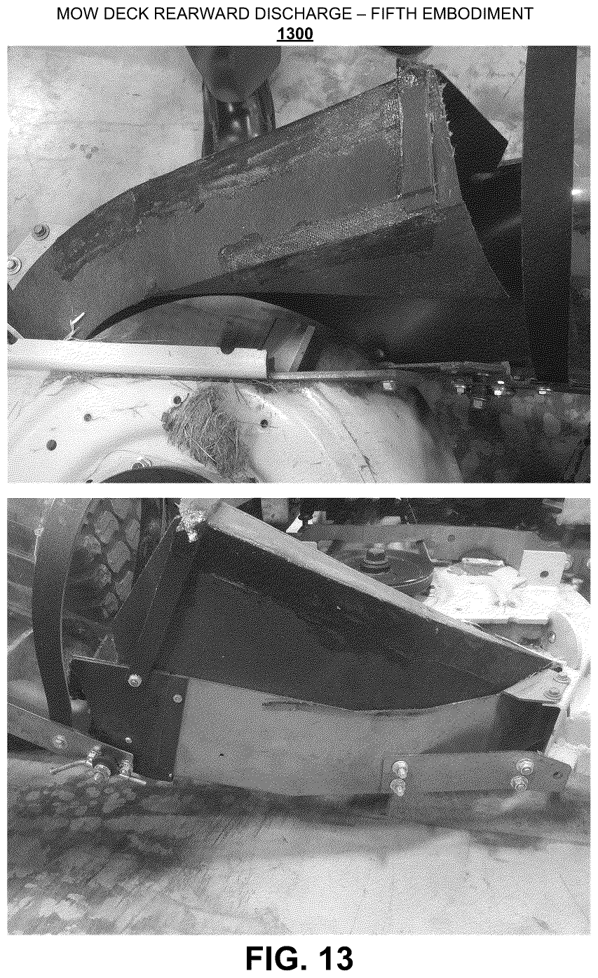

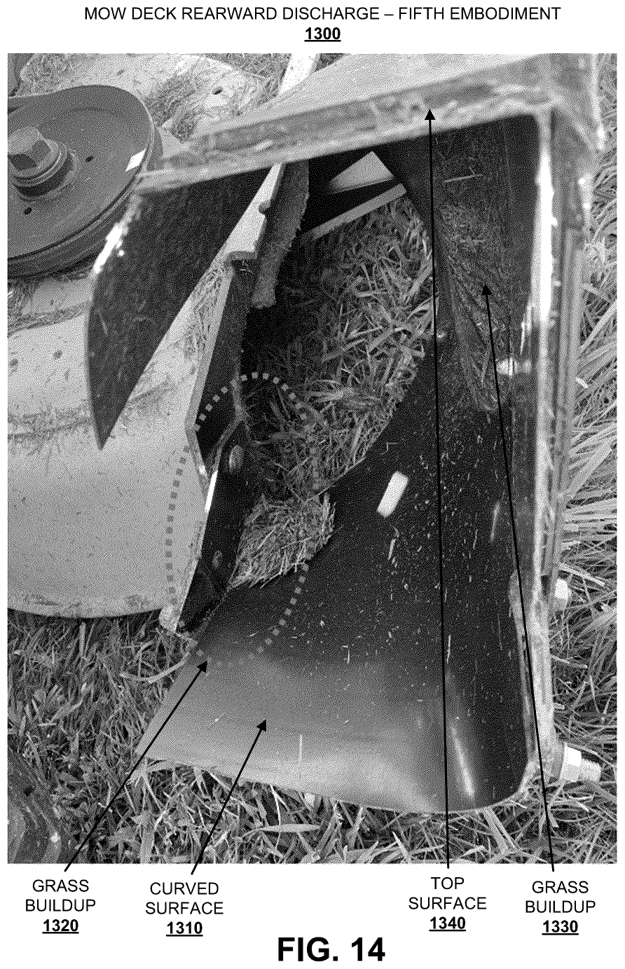

Referring to FIG. 13, illustrated are photographs showing a top view (top image) and outside view (bottom image) of a prototype of a fifth example embodiment 1300 of a rearward side discharge, according to various aspects discussed herein. FIG. 14 shows a photograph of an interior of the prototype of the fifth example embodiment 1300 of a rearward discharge housing according to various aspects discussed herein. In contrast to the fourth example embodiment, the fifth example embodiment has an elevated hood on the housing, and the upper part of the inner surface has been moved outward away from the bottom surface, which creates a flow pattern that draws air and material entering the fifth example embodiment upward and away from the mow deck into the fifth example embodiment. Additionally, the bottom surface of the fifth example embodiment comprises a curved surface 1310 that creates a smooth transition from the curve of the inner surface to the discharge opening of the fifth example embodiment, reducing loss of kinetic energy in material. Circled in FIG. 14 is grass buildup 1320 that occurred during testing of the prototype at a corner between the curved surface 1310 and an inside surface of the fifth example embodiment. Additional grass buildup 1330 occurred above a vertical portion of the inner surface of the fifth example embodiment. The fifth example embodiment also has a top surface 1340 that rises significantly above the surface of the mow deck (e.g., the height of top surface 1340 can be more than the height of the inner surface of the rearward discharge housing, more than 1.5× the height of the inner surface, more than 2× the height of the inner surface, more than 2.5× the height of the inner surface, more than 3× the height of the inner surface, etc.). This elevated top surface 1340 can allow space for a range of trajectories of material (e.g., ranging from an upward angle of curved surface 1310 for material moving along curved surface 1310 to an upper trajectory that can make an angle of up to 45° above horizontal or potentially more, which can depend on factors such as the material (e.g., type, density, moisture content, etc.), mow blade tip speed, etc. The elevated top surface 1340 allows material to retain a greater portion of its kinetic energy by not losing energy via impact with top surface 1340, allowing for more efficient movement of material through the housing (e.g., to an active or passive bagging system, etc.).

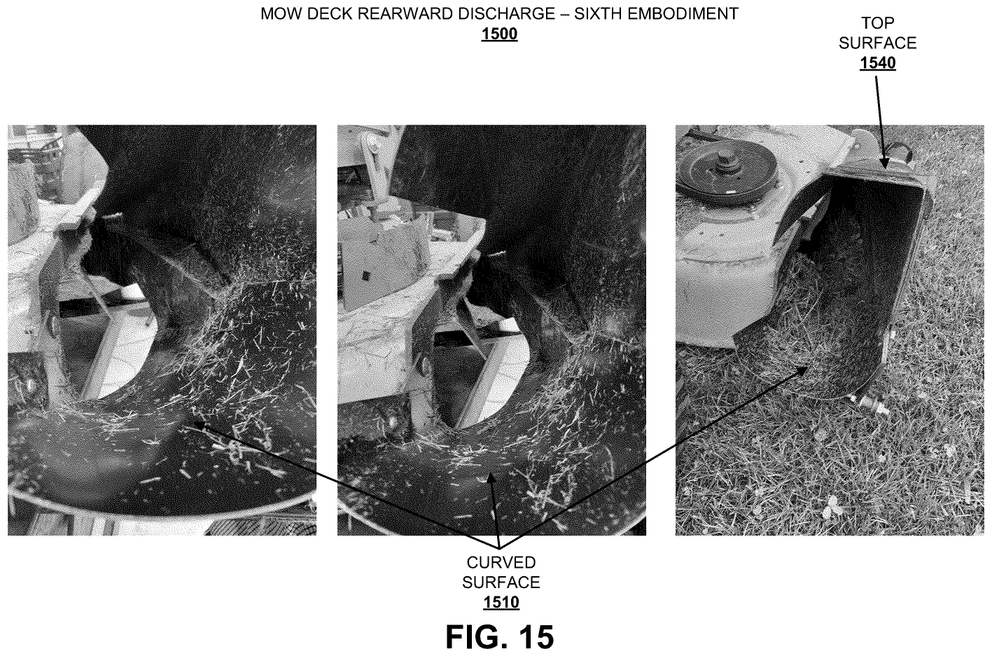

Referring to FIG. 15, illustrated are three photographs of a prototype of a sixth example embodiment 1500 of a rearward side discharge, according to various aspects discussed herein. The sixth example embodiment 1500 is similar to the fifth example embodiment 1300, but curved surface 1510 removes the corner where grass buildup 1320 occurred in embodiment 1300.

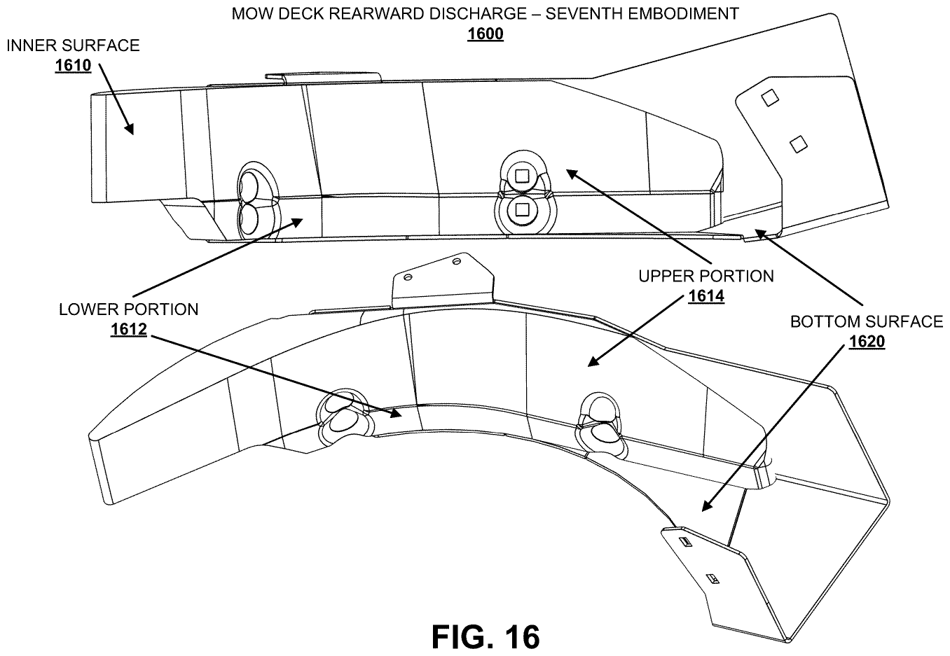

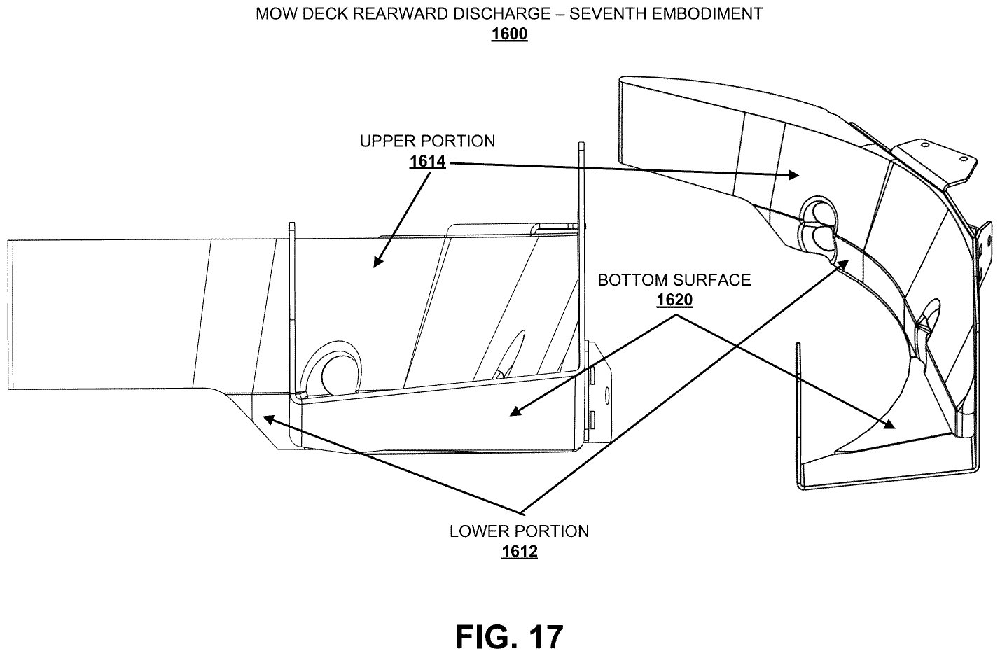

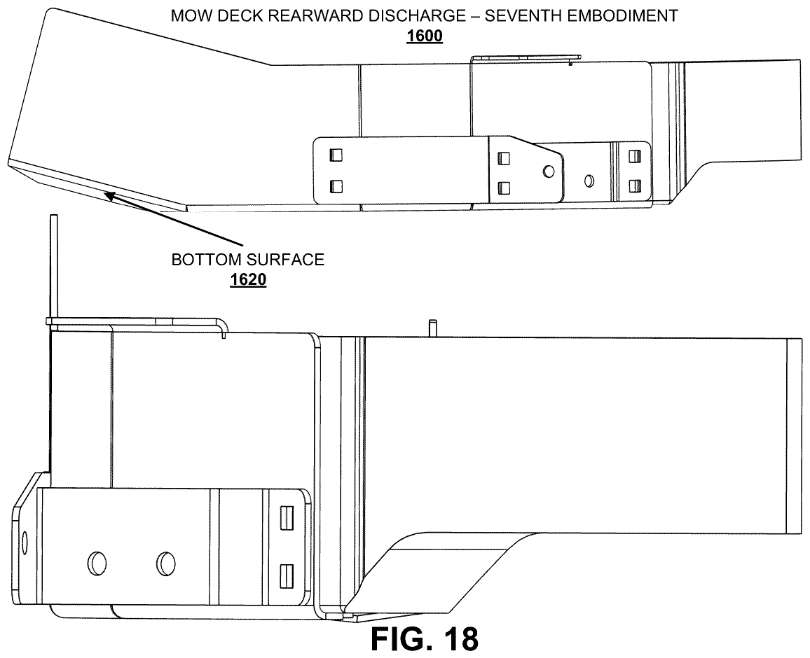

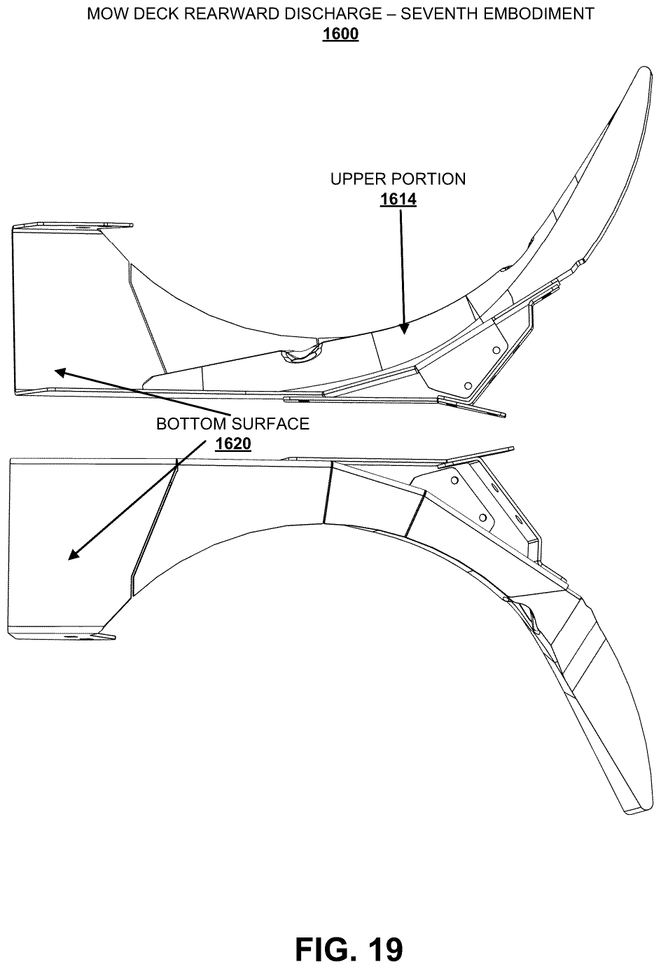

FIGS. 16-19 show various views of a seventh example embodiment 1600 of a rearward discharge housing. FIG. 16 shows an inside view (top) and an inside perspective view (bottom) of the seventh example embodiment 1600 of a rearward discharge housing, according to various aspects discussed herein. FIG. 17 shows a rear view (left) and an elevated rear view (right) of the seventh example embodiment 1600 of a rearward discharge housing, according to various aspects discussed herein. FIG. 18 shows an outside view (top) and a front view (bottom) of the seventh example embodiment 1600 of a rearward discharge housing, according to various aspects discussed herein. FIG. 19 shows a top view (top) and a bottom view (bottom) of the seventh example embodiment 1600 of a rearward discharge housing, according to various aspects discussed herein. The inner surface 1610 of the seventh example embodiment 1600 can be substantially vertical near the front of embodiment 1600. A lower portion 1612 of the inner surface 1610 of embodiment 1600 is substantially vertical throughout its length. An upper portion 1614 of inner surface 1610 can be vertical near the front of embodiment 1600 and can tilt outward at an angle relative to vertical that can gradually increase along the upper portion 1614 to a maximum angle relative to vertical (e.g., 45° or less, 40° or less, 35° or less, etc.), creating a flow pattern that draws air and material entering embodiment 1600 upward and away from the mow deck while maintaining the majority of its kinetic energy, similarly to the fifth embodiment. However, because of the gradual transition of upper portion 1614 and the non-horizontal angle maintained throughout upper portion, turf or other material is less likely to accumulate on upper portion 1614 than in similar portions of the fifth embodiment (e.g., grass buildup 1330).

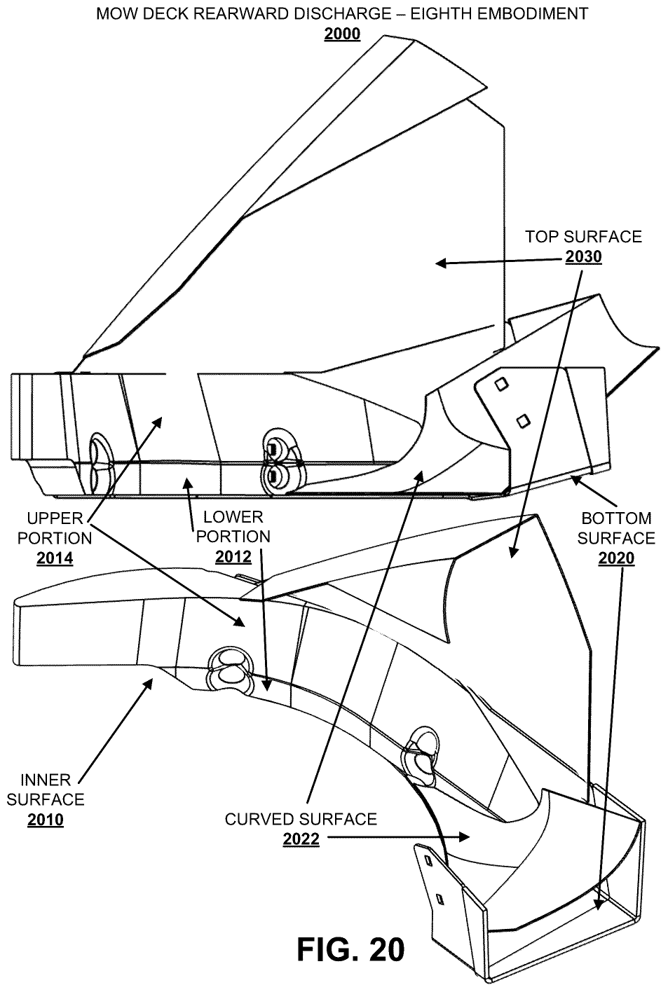

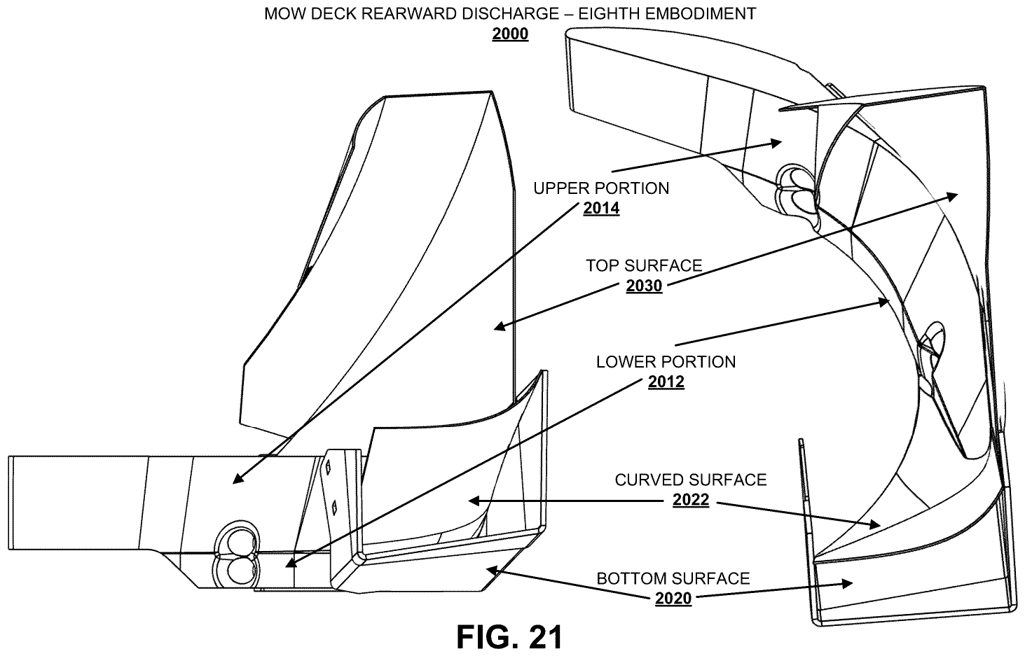

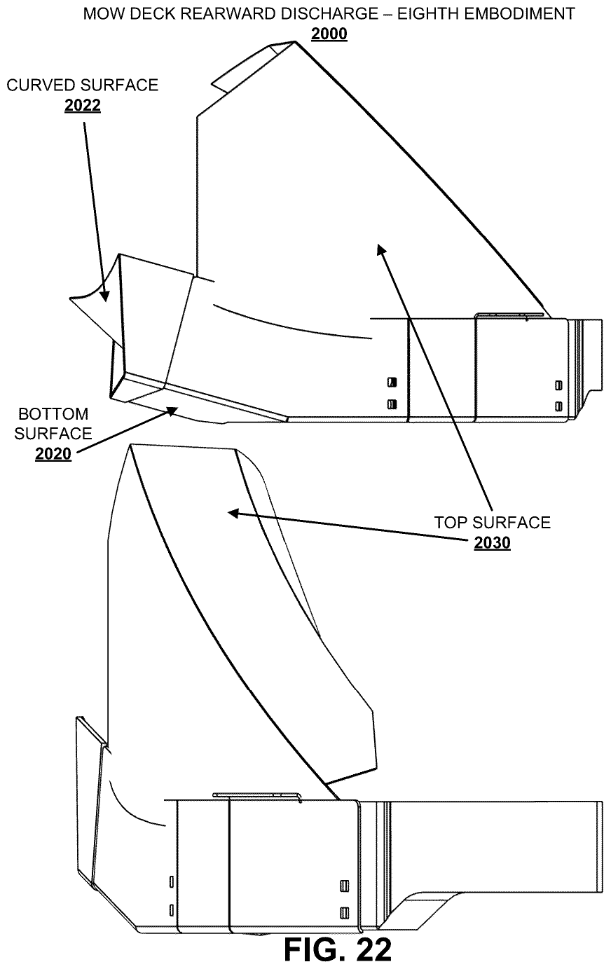

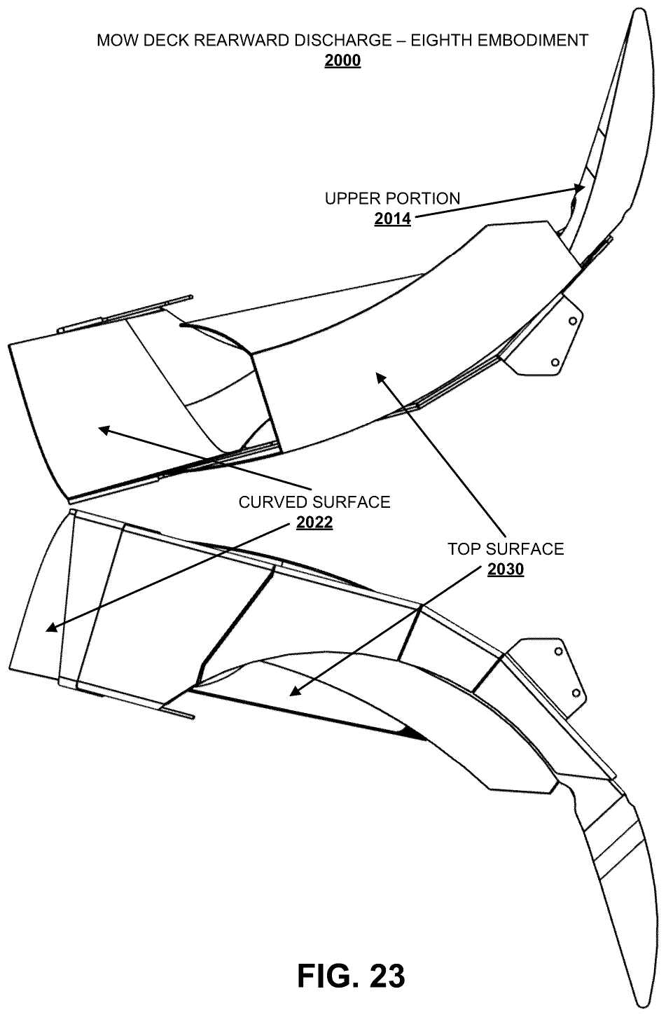

FIGS. 20-23 show various views of an eighth example embodiment of a rearward discharge housing 2000. FIG. 20 shows an inside view (top) and an inside perspective view (bottom) of the eighth example embodiment 2000 of a rearward discharge housing, according to various aspects discussed herein. FIG. 21 shows a rear view (left) and an elevated rear view (right) of the eighth example embodiment 2000 of a rearward discharge housing, according to various aspects discussed herein. FIG. 22 shows an outside view (top) and a front view (bottom) of the eighth example embodiment 2000 of a rearward discharge housing, according to various aspects discussed herein. FIG. 23 shows a top view (top) and a bottom view (bottom) of the eighth example embodiment 2000 of a rearward discharge housing, according to various aspects discussed herein. The eighth example embodiment 2000 can be similar to the seventh example embodiment with respect to the inner surface 2010 and bottom surface 2020. Additionally, however, eighth example embodiment 2000 can comprise a curved surface 2022 similar to curved surface 1310 of fifth embodiment 1300 or to curved surface 1510 of sixth embodiment 1500, which can facilitate flow of material through the eighth example embodiment 2000 with greater kinetic energy, enabling more effective and efficient bagging of material. Eighth example embodiment 2000 can also comprise an elevated top surface 2030 that can be similar to top surface 1340 of the fifth embodiment or top surface 1540 of the sixth embodiment, allowing material to move freely along a range of trajectories through the rearward discharge housing. In general, inner surface 2010 can be around 0.25 in. away from the tips of mow blades (e.g., 0.125-0.375 in., etc.) throughout a front portion of the inner surface, which can have a shape substantially the same as the arc of a circle centered around the center of rotation of the mow blades, until departing from the circular arc (at or near the front end of bottom surface 2020) at an angle above horizontal (e.g., 35° or less, 30° or less, 25° or less, 20° or less, etc.), behind which the inner surface can be substantially straight, piecewise straight, curved at a greater radius of curvature, etc. The front end of bottom surface 2020 can continue the circular arc of the front portion of inner surface 2010 until the arc ends adjacent to the mow deck.

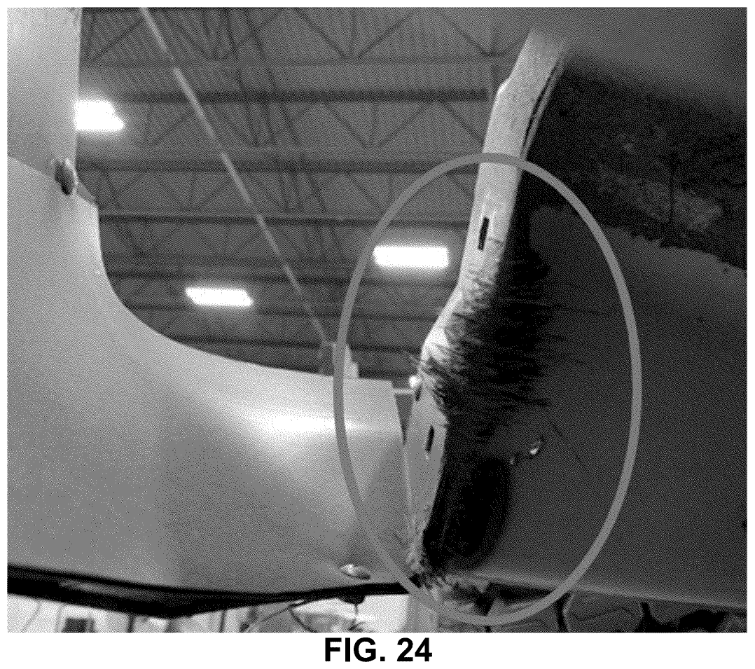

FIG. 24 shows grass buildup on an edge between the mow deck and a prototype of an embodiment similar to the eighth embodiment, according to various aspects discussed herein. As can be seen in FIG. 24, the rear of multiple discharge housing embodiments discussed herein can form a relatively sharp edge where it meets the mow deck, and grass or other material can build up on that edge. Buildup of grass or other material at this interface can be minimized in multiple ways, such as by providing a baffle or other surface to eliminate the sharp edge at the interface (e.g., such as employed in the ninth example embodiment, discussed below, etc.) and/or by preventing/minimizing grass from being directed toward that edge (e.g., such as via the center baffle discussed below, which can be employed in one or more grass discharge systems with any of a variety of discharge housings discussed herein, etc.).

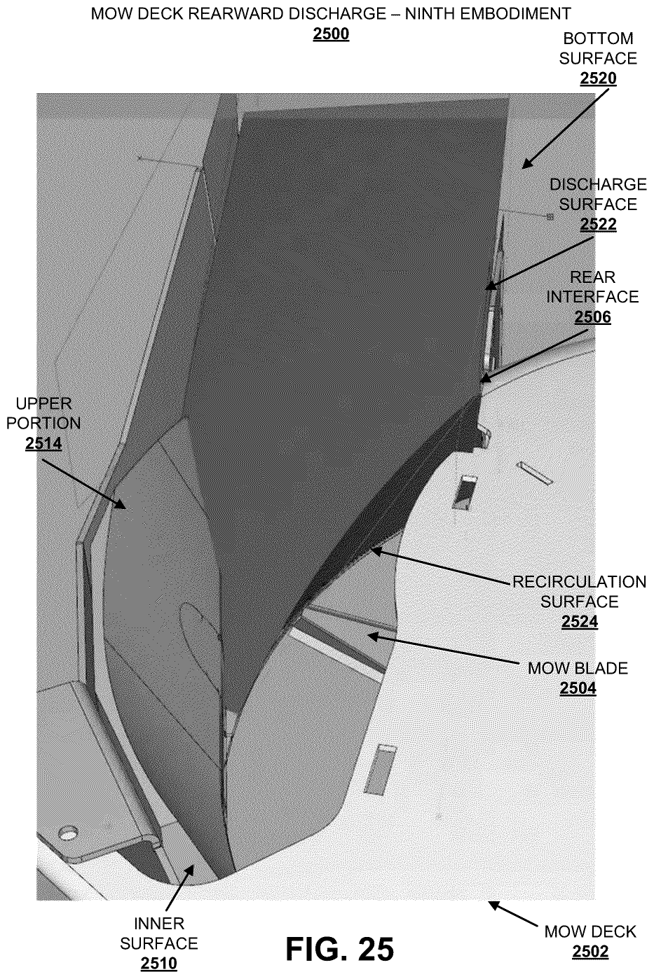

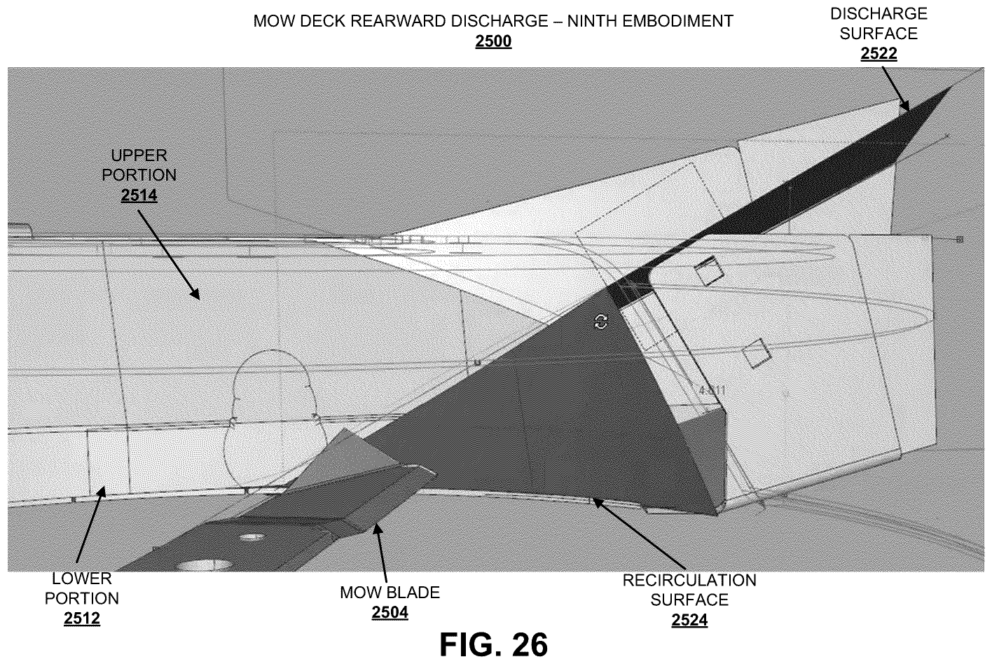

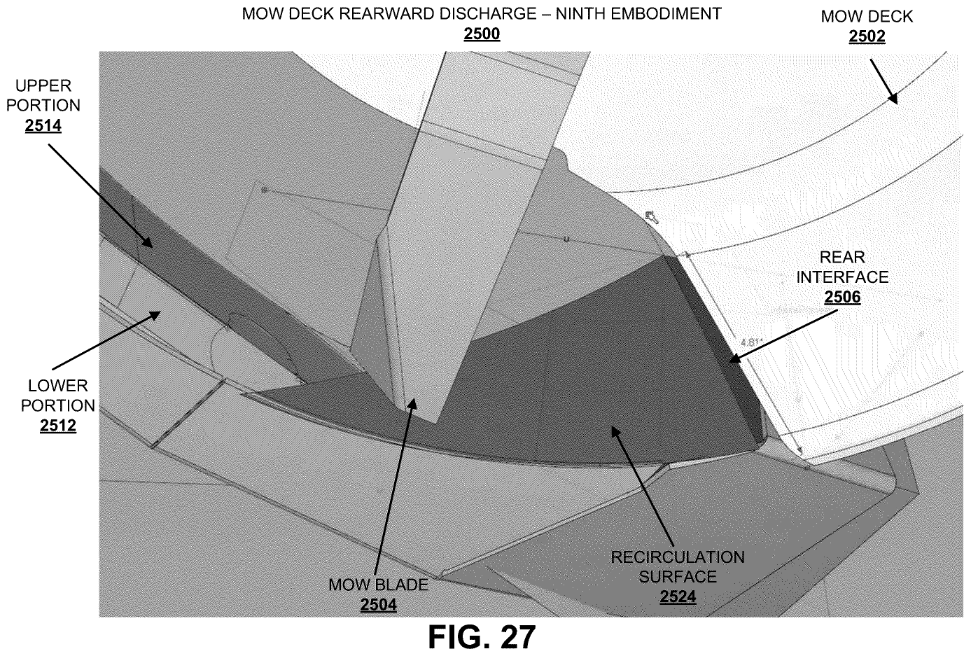

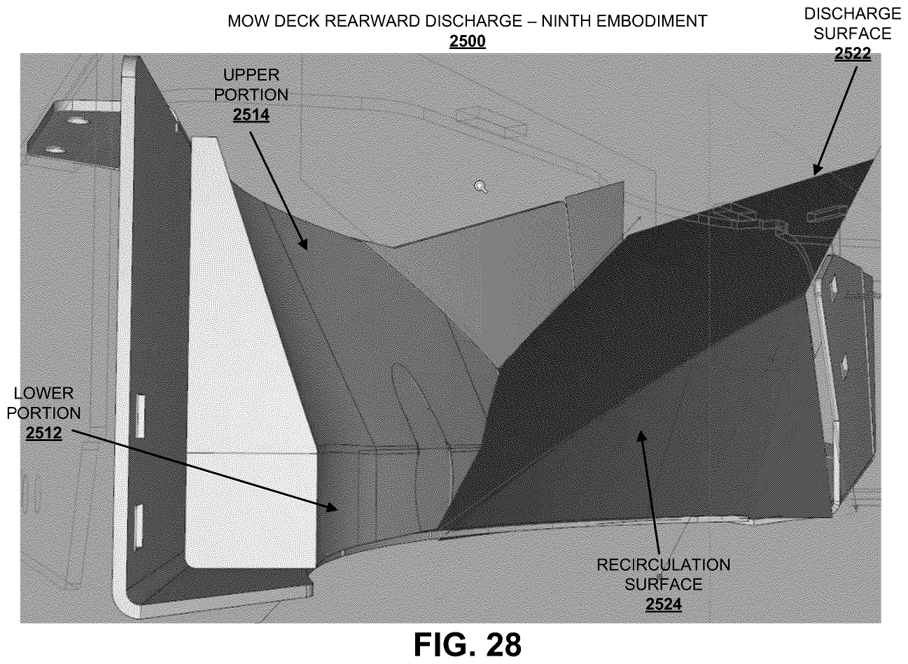

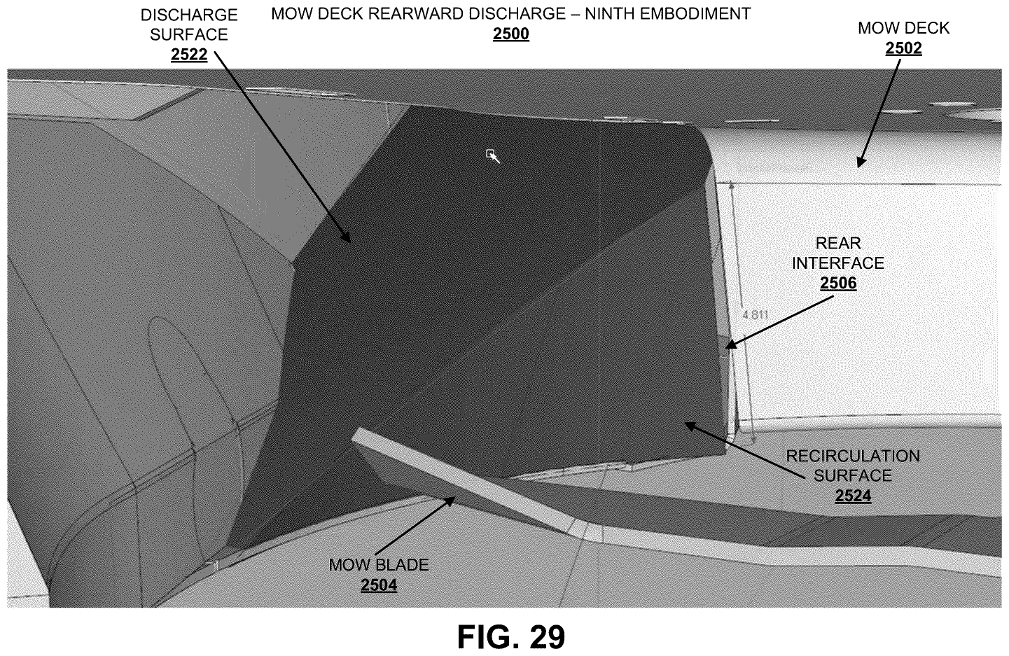

FIGS. 25-29 show various views of a ninth example embodiment of a rearward discharge housing 2500 comprising a bottom surface that facilitates discharge of material moving with the outer edge of mow blades and recirculation of other material, employable as or in connection with various embodiments discussed herein. FIG. 25 shows a top front view of the ninth example embodiment 2500 along with mow deck 2502 and a mow blade 2504, according to various aspects discussed herein. FIG. 26 shows an inside view of the ninth example embodiment 2500 along with a mow blade 2504, according to various aspects discussed herein. FIG. 27 shows a bottom inside view of the ninth example embodiment 2500 along with mow deck 2502 and a mow blade 2504, according to various aspects discussed herein. FIG. 28 shows a front view of the ninth example embodiment 2500, according to various aspects discussed herein. FIG. 29 shows a front inside view of the ninth example embodiment 2500 along with mow deck 2502 and a mow blade 2504, according to various aspects discussed herein. Ninth example embodiment 2500 can be similar to the eighth example embodiment 2000 (e.g., inner surface 2510 can have a similar lower portion 2512 and upper portion 2514 to inner surface 2000, etc.), but can include a bottom surface 2520 that facilitates more efficient discharge of material (e.g., grass clippings, leaves, etc.) without buildup of material at the interface between the rear of housing 2500 and mow deck 2502.

Bottom surface 2520 can comprise a discharge surface 2522 that can direct material moving along the inner surface of mow deck 2502 with or near the tips of mow blades 2504 upward and out through housing 2500. The shape, angle, and/or elevation of discharge surface 2522 can vary between embodiments (e.g., compare curved surface 2022, bottom surface 1620, curved surface 1510, curved surface 1310, bottom surface 720, etc.). For material not moving with or near the tips of mow blades 2504, recirculation surface 2524 can direct that material to the inside surface of mow deck 2502 to be recirculated by mow blades 2504 for subsequent discharge via discharge surface 2522.

In various embodiments, recirculation surface 2524 can meet discharge surface at an edge that can be a sharp transition (e.g., as shown in FIGS. 25-29, etc.) or can be a more gradual (e.g., rounded, comprising one or more intermediate surfaces, etc.) transition. In some embodiments, recirculation surface 2524 can have a vertical cross-section that can be one or more of (e.g., at different positions along its length, etc.): the same as or similar to the vertical cross-section of mow deck 2502, vertical, sloped or curved such that a lower edge is farther from the center of a nearest mow spindle than an upper edge, etc. In various embodiments, a vertical cross-section of bottom surface 2520 at a rear interface 2506 with mow deck 2502 can match the vertical cross-section of mow deck 2502 at the rear interface 2506, such that material does not have a relatively sharp edge on which to collect (e.g., as in FIG. 24) but a relatively smooth transition from bottom surface 2520 to mow deck 2502 at the rear interface 2506. In example embodiment 2500, bottom surface 2520 is shown as a separate component from inner surface 2510, in other embodiments bottom surface 2520 and inner surface 2510 can be formed as portions of a single component.

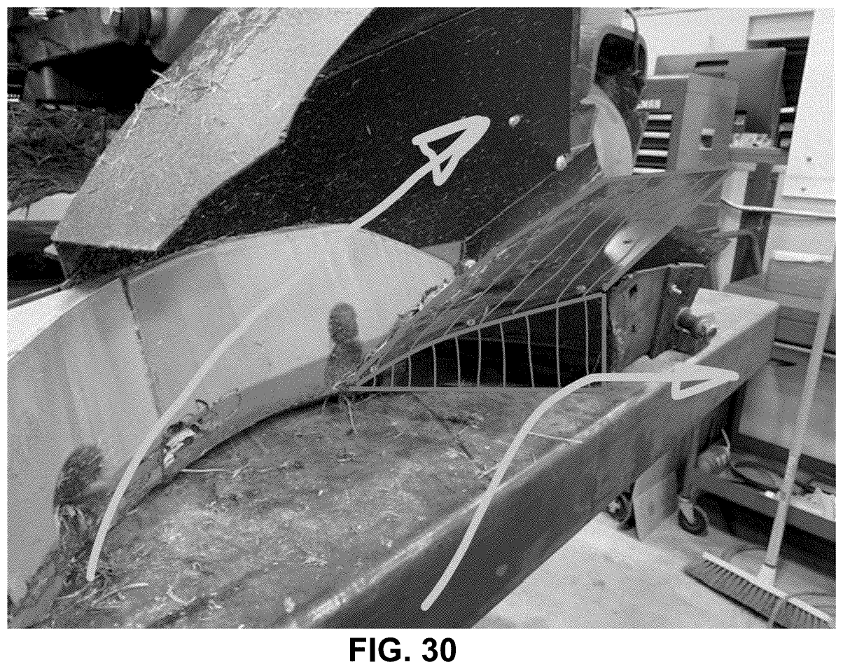

Referring to FIG. 30, illustrated is an image of an example prototype of a discharge housing with bottom surface similar to the ninth example embodiment 2500, according to various aspects discussed herein. FIG. 30 has arrows showing flow of air material up the discharge surface (the top left arrow) and past the recirculation surface (the bottom right arrow).

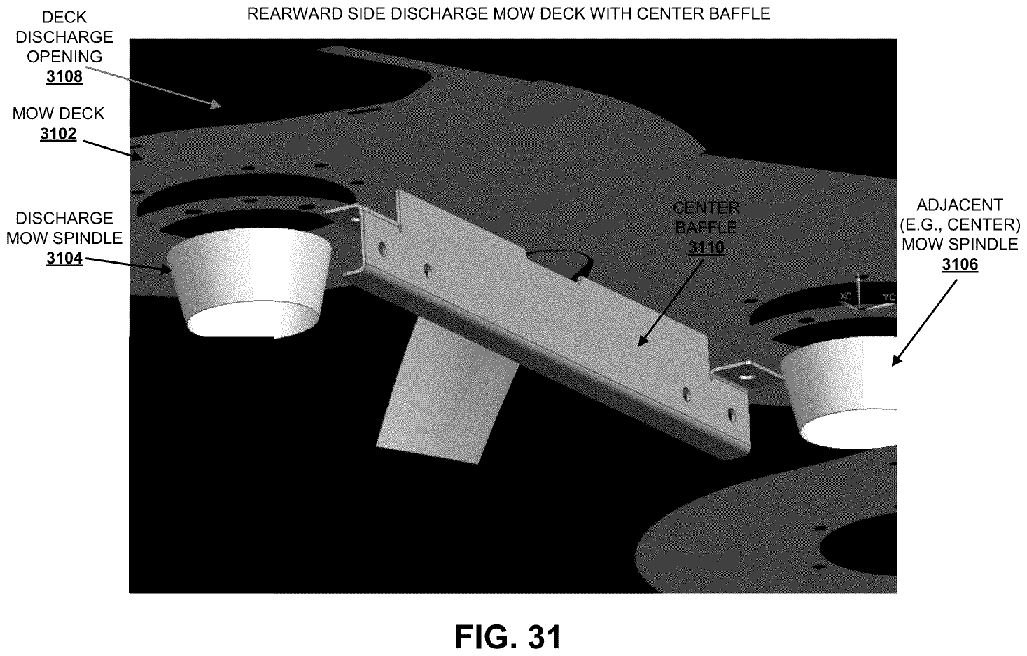

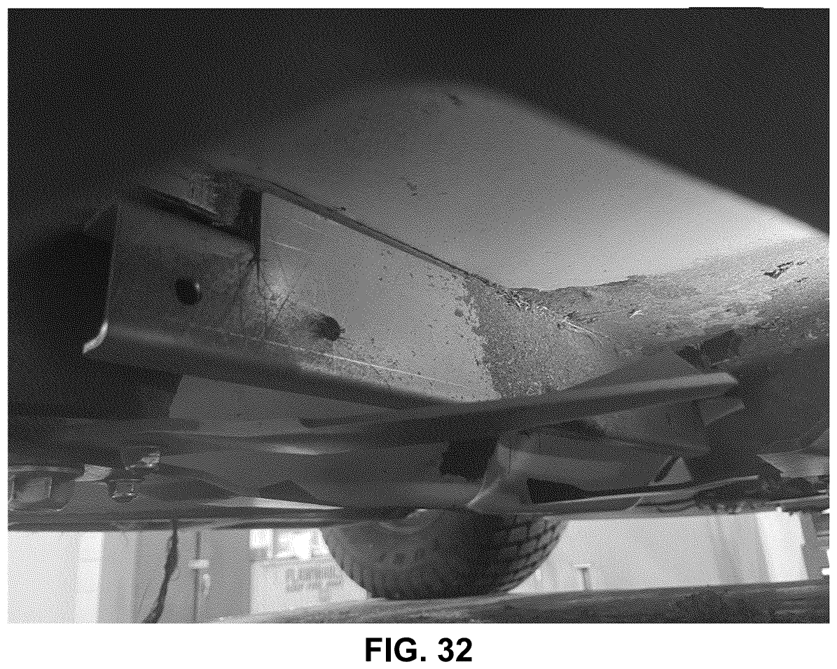

Referring to FIG. 31, illustrated is a bottom perspective view of a mow deck 3102 with center baffle 3110, according to various aspects discussed herein. Center baffle 3110 can be employed in mow decks with more than one mow spindle (e.g., discharge mow spindle 3104 adjacent to deck discharge opening 3108, adjacent mow spindle 3106, and optionally one or more other mow spindles). Center baffle 3110 can be arranged between discharge mow spindle 3104 and an adjacent mow spindle 3106. Center baffle 3110 can prevent flow of material directly from adjacent mow spindle 3106 to deck discharge opening 3108 (and to any discharge housing such as those discussed herein), as such material is more likely to cause grass buildup and blockages than material flowing along the inner surface of the mow deck adjacent to blade tips of mow blades of discharge mow spindle 3104. Center baffle 3110 can block a direct path of material from mow spindle 3106 to the discharge opening 3108. With the inclusion of center baffle 3110, material that would otherwise flow directly from adjacent mow spindle 3106 to discharge opening 3108 instead flows with discharge mow spindle 3104 and is more likely to be flowing with blade tips of mow spindle 3104 as it reaches discharge opening 3108, for more efficient discharge of material. The example center baffle 3110 has a substantially vertical face and is mounted between mow spindles 3104 and 3106, with a first end adjacent to and behind mow spindle 3106 and a second end adjacent to and in front of mow spindle 3104. The arrangement of center baffle 3110 shown in FIG. 31 is based on the arrangement of mow spindles for mow deck 3102, and in various embodiments, center baffles can be employed differing from center baffle 3110 in one or more of size, shape, or position, while providing similar benefits to center baffle 3110 in connection with discharge of material from the associated mow deck to which that center baffle is connected. Referring to FIG. 32, illustrated is a photograph of a prototype center baffle installed on a mow deck, in connection with various aspects discussed herein.

Various embodiments can be or comprise a rearward discharge housing with any of a variety of aspects or features discussed herein, which can receive material from a mow deck via a discharge opening, intake interface, or input to the discharge housing and expel the material via a second opening or output near the rear of the discharge housing. Additional embodiments can be or comprise a grass discharge system employable in connection with a mow deck, comprising one or more of a rearward discharge housing and/or center baffle, either of which can be with any of a variety of aspects or features discussed herein. Further embodiments can comprise a lawn maintenance apparatus comprising one or more of a rearward discharge housing and/or center baffle, either of which can be with any of a variety of aspects or features discussed herein. Although several specific example embodiments are shown and discussed, other embodiments can vary from embodiments discussed herein in one or more ways. For example, as discussed above in connection with FIG. 2, a rearward-directed discharge opening can optionally be implemented with a deck cut-away that removes a section of mow deck and opens a rearward arc of the mow deck. The extent of the cut-away can vary between embodiments, and in some embodiments can have a greater or lesser angle between the rearward discharge housing and the rear end of the cut-away than shown in various embodiments. As another example, a front portion of the inner surface can define a circular arc of a length that can vary, and in various embodiments, the circular arc defined by the front portion of the inner surface can redirect material to a discharge angle or to an intermediate angle closer (e.g., 20-30° from rear, etc.) to the discharge angle (e.g., 10-20° from rear, etc.) than an intake angle (e.g., around angle to rear 130, etc.). Additional aspects can also vary, such as the angle to rear of the rearward discharge housing, the extent or angle of lift of the rearward discharge housing, etc.

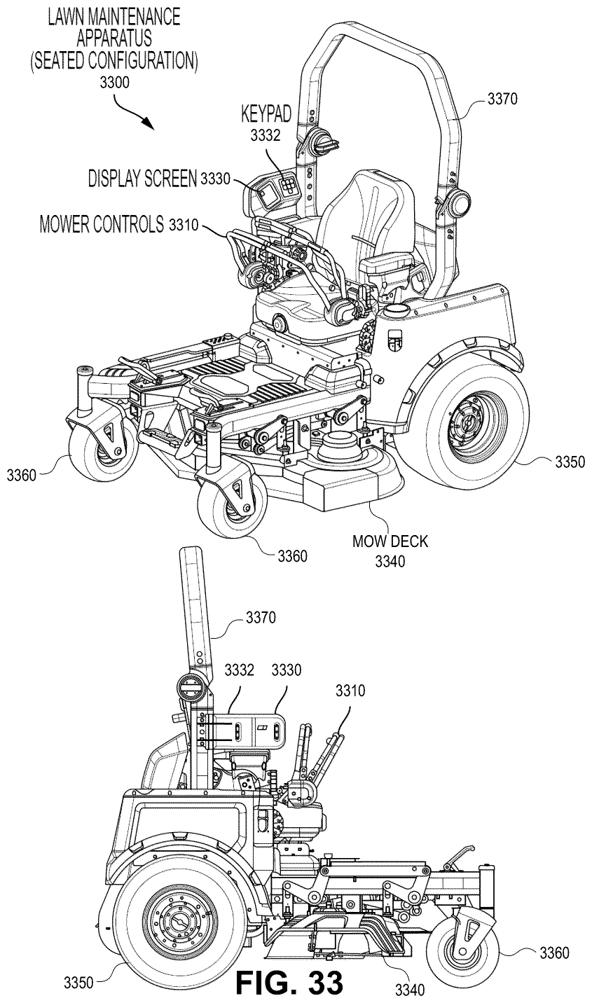

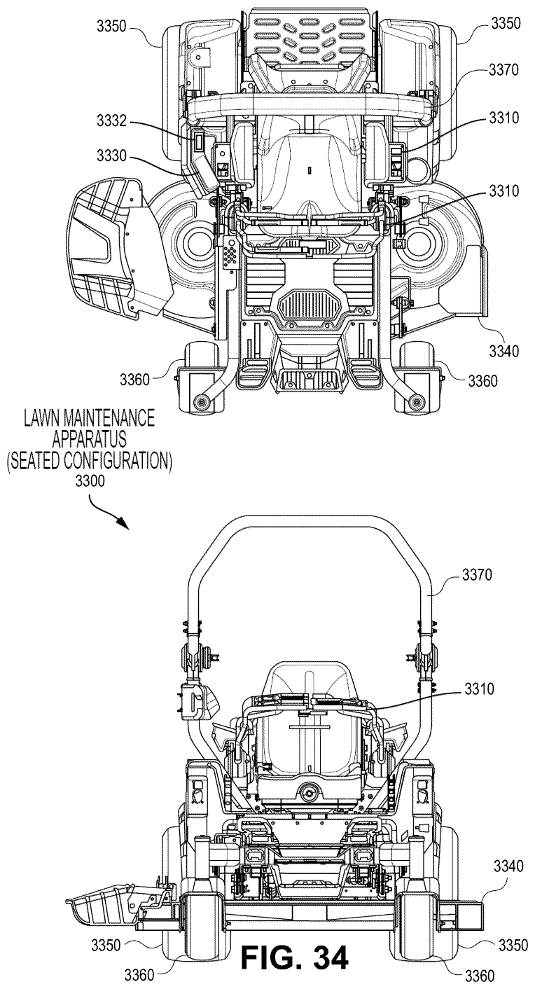

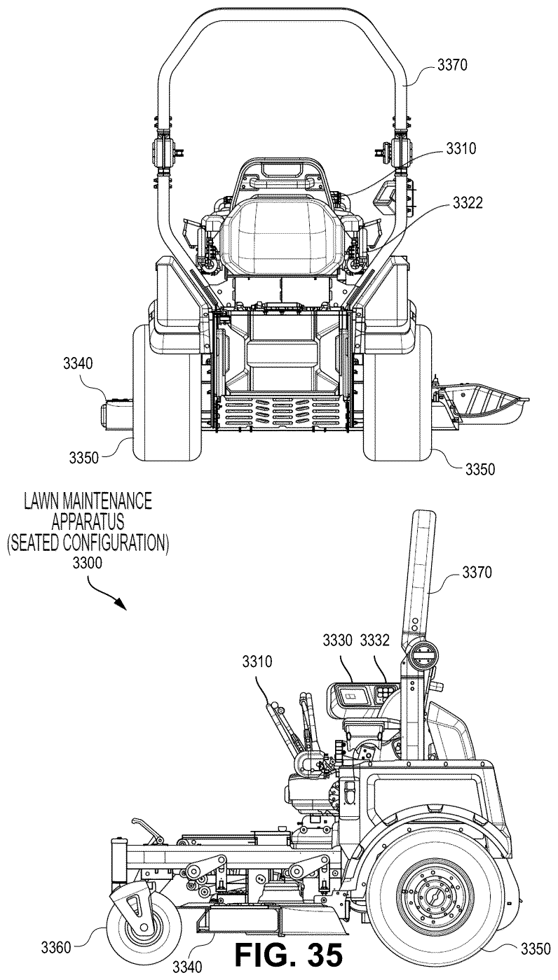

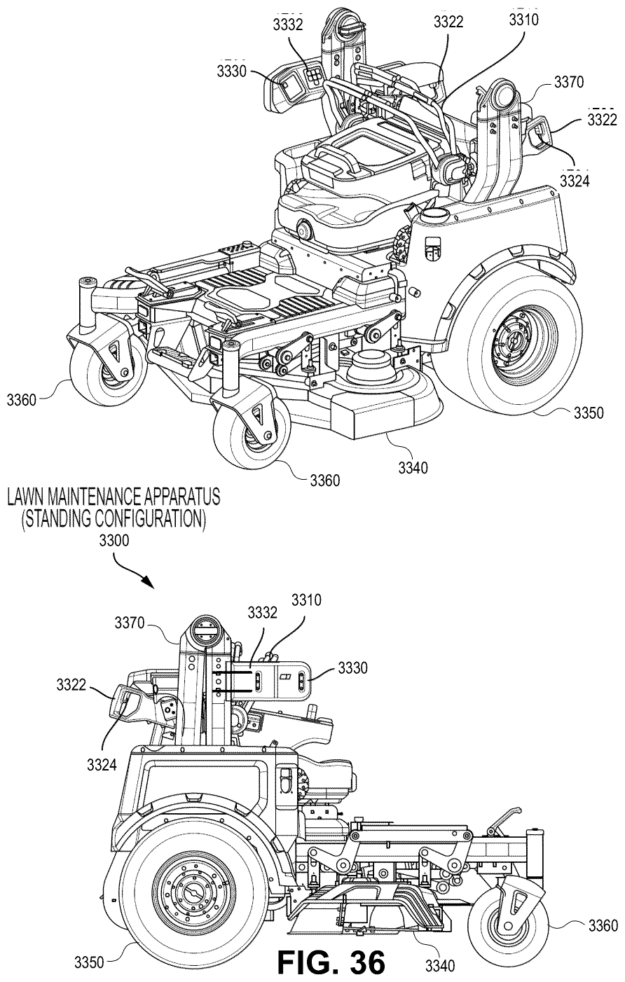

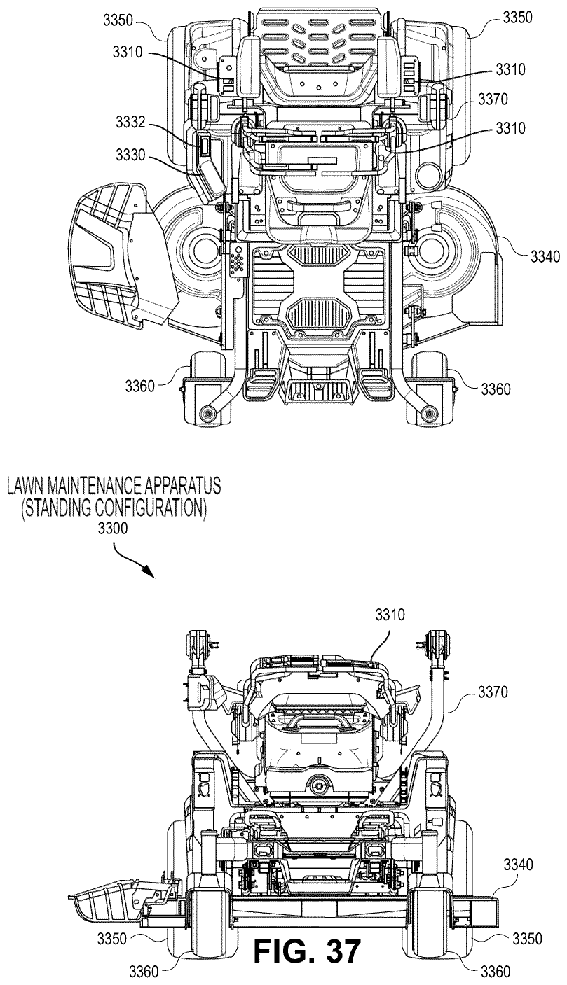

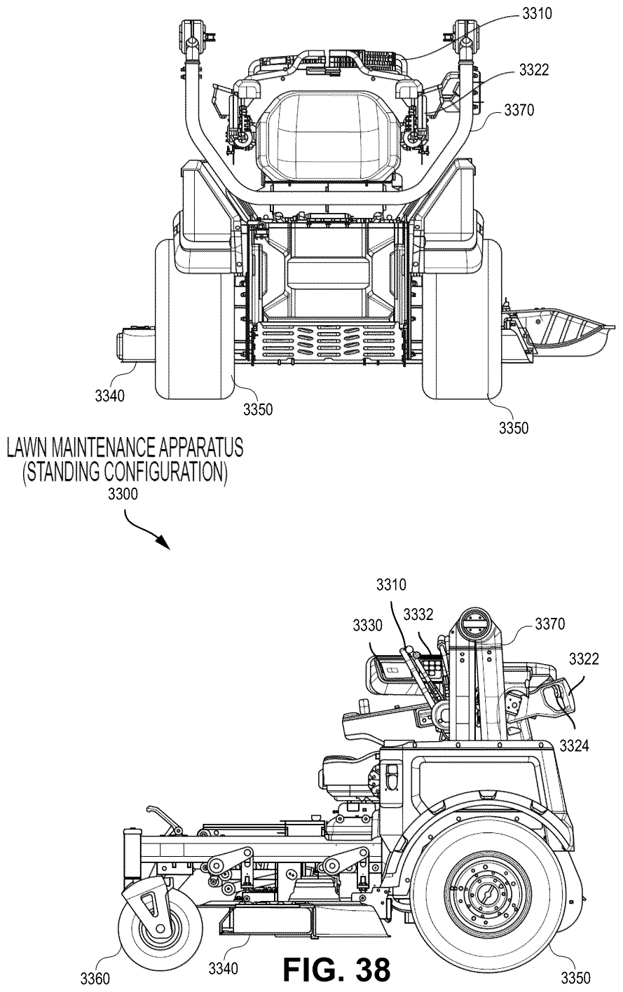

Various embodiments can be employed on a seated lawn maintenance apparatus and/or a standing lawn maintenance apparatus. FIGS. 33-38 below illustrate various views of an example embodiment of a convertible seated/standing lawn-maintenance apparatus that can employ a mow deck and/or grass discharge according to any of a variety of embodiments discussed herein. FIGS. 33-38 illustrate line images of an example embodiment of a lawn maintenance apparatus 3300 in a seated configuration (FIGS. 33-35) and a standing configuration (FIGS. 36-38). FIG. 33 illustrates left perspective (top) and right (bottom) views of the example embodiment 3300 in the seated configuration, according to various aspects discussed herein. FIG. 34 illustrates top (top) and front (bottom) views of the example embodiment 3300 in the seated configuration, according to various aspects discussed herein. FIG. 35 illustrates rear (top) and left (bottom) views of the example embodiment 3300 in the seated configuration, according to various aspects discussed herein. FIG. 36 illustrates left perspective (top) and right (bottom) views of the example embodiment 3300 in the standing configuration, according to various aspects discussed herein. FIG. 37 illustrates top (top) and front (bottom) views of the example embodiment 3300 in the standing configuration, according to various aspects discussed herein. FIG. 38 illustrates rear (top) and left (bottom) views of the example embodiment 3300 in the standing configuration, according to various aspects discussed herein.

Embodiment 3300 is an example lawn maintenance apparatus that can comprise or employ a mow deck as discussed herein (e.g., mow deck 100, etc.), with exceptions and/or additions as discussed below. Embodiment 300 can be powered electrically, based on an engine (e.g., gas, diesel, etc.), hybrid, etc. The prime mover (not shown) of embodiment 3300 can power various powered components of embodiment 3300, such as mow deck 3340 and drive wheels 3350. Embodiment 3300 can also comprise one or more non-driven wheels 3360, which can be caster wheels and/or actively steered wheels, etc.

Embodiment 3300 comprises mower controls 3310 (e.g., comprising lap bars, armrest mounted controls, etc.) that can be moved along control mounts 3320 via depressing triggers 3324 on handles 3322 and pushing or pulling the controls 3310 to the seated (forward) or standing (rearward) position where control mount 3320 can be again locked into position. The control adjustment mechanism includes a user handle or grip 3322 along with a trigger or actuator 3324 for adjusting the controls 3310 between standing mode operation in a rearward position and sitting mode operation in a forward position.

Additionally, in embodiment 3300 display screen 3330 and keypad 3332 can be mounted from the rollover protection (ROP) bar 3370, allowing access in both the seated and standing modes of operation.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, aspects (e.g., an arrangement, shape, or positioning of components, etc.) depicted in one embodiment can be swapped with aspects of another embodiment, optionally excluding some aspects or including other aspects illustrated in a third embodiment, according to design creativity of one of ordinary skill in the art. Still further, components of disclosed machines/devices/motors can also interact with one or more other components not specifically described herein but known by those of skill in the art.

In regard to the various functions performed by the above described components, machines, apparatuses, devices, processes, control operations and the like, the terms (including a reference to a “means”) used to describe such components, etc., are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as mechanical structures, as well as lawn maintenance equipment comprising rearward discharge systems or structures as discussed herein.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be construed as being limited to those illustrations. Rather, any suitable combination or subset of elements from one drawing(s) can be applied to other embodiments in other drawings where suitable to one of ordinary skill in the art to accomplish objectives disclosed herein, objectives known in the art, or objectives and operation reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An apparatus, comprising:
an intake interface that defines a first opening in the apparatus and is configured to couple with a discharge port of a mow deck of a mowing machine, wherein the intake interface is configured to receive material from the mow deck at a first horizontal angle that is at least 55° away from a rear direction relative to the mow deck;
an inner surface configured to redirect material received via the intake interface to a second horizontal angle that is within 45° of the rear direction; and
an output configured to expel the material from the apparatus.

2. The apparatus of claim 1, wherein a front portion of the inner surface defines a circular arc segment having a substantially constant distance from a tip of a mow blade closest to the discharge port within the mow deck, wherein the front portion is configured to redirect the material from the first horizontal angle to a third horizontal angle that is within 20° of the rear direction.

3. The apparatus of claim 2, wherein the substantially constant distance is at least 0.125 in. and at most 0.375 in.

4. The apparatus of claim 1, wherein the second horizontal angle is within 30° of the rear direction.

5. The apparatus of claim 1, further comprising a bottom surface configured to redirect the material upward into a range of trajectories having vertical angles equal to or greater than a first vertical angle defined by at least a portion of the bottom surface.

6. The apparatus of claim 5, wherein the first vertical angle is at least 10° above horizontal.

7. The apparatus of claim 5, wherein:
a front portion of the bottom surface defines a circular arc at a substantially constant distance from a tip of a mow blade of the mow deck, wherein the substantially constant distance is at least 0.125 in. and at most 0.375 in; and
the bottom surface further comprises a recirculation surface configured to direct a portion of the material away from the intake interface to recirculate within an interior of the mow deck.

8. The apparatus of claim 1, wherein at least part of an upper portion of the inner surface is sloped outward away from the mow deck at a vertical angle of 45° or more above horizontal.

9. The apparatus of claim 8, wherein the upper portion of the inner surface defines a discharge surface and a recirculation surface separated from the discharge surface by a surface edge, wherein the recirculation surface is approximately vertical and the discharge surface has the vertical angle of 45° or more above horizontal.

10. The apparatus of claim 1, wherein the output is configured to expel the material into one of an active bagging system or a passive bagging system.

11. A lawn maintenance apparatus, comprising:
a frame;
a mow deck attached to the frame; and
a rearward discharge housing, comprising:
an intake interface that defines a first opening in the housing and is configured to couple with a discharge port of the mow deck, wherein the intake interface is configured to receive material from the mow deck at a first horizontal angle that is at least 55° away from a rear direction relative to the mow deck;
an inner surface configured to redirect material received via the intake interface to a second horizontal angle that is within 45° of the rear direction; and
an output configured to expel the material from the housing.

12. The lawn maintenance apparatus of claim 11, wherein a front portion of the inner surface defines a circular arc segment at a substantially constant distance from a tip of a mow blade of the mow deck, wherein the front portion is configured to redirect the material from the first horizontal angle to a third horizontal angle that is within 20° of the rear direction.

13. The lawn maintenance apparatus of claim 12, wherein the substantially constant distance is at least 0.125 in. and at most 0.375 in.

14. The lawn maintenance apparatus of claim 11, further comprising a bottom surface configured to redirect the material upward into a range of trajectories having vertical angles equal to or greater than a first vertical angle defined by at least a portion of the bottom surface.

15. The lawn maintenance apparatus of claim 14, wherein the first vertical angle is at least 10° above horizontal.

16. The lawn maintenance apparatus of claim 14, wherein:
a front portion of the bottom surface defines a circular arc at a substantially constant distance from tips of mow blades of the mow deck, wherein the substantially constant distance is at least 0.125 in. and at most 0.375 in; and
the bottom surface further comprises a recirculation surface configured to direct a portion of the material away from the intake interface to recirculate within an interior of the mow deck.

17. The lawn maintenance apparatus of claim 11, wherein at least part of an upper portion of the inner surface is sloped outward away from the mow deck at a vertical angle of 45° or more above horizontal.

18. The lawn maintenance apparatus of claim 17, wherein the upper portion of the inner surface defines a discharge surface and a recirculation surface separated from the discharge surface by a surface edge, wherein the recirculation surface is approximately vertical and the discharge surface has the vertical angle of 45° or more above horizontal.

19. The lawn maintenance apparatus of claim 11, wherein the output is configured to expel the material into one of an active bagging system or a passive bagging system.

20. The lawn maintenance apparatus of claim 11, further comprising a center baffle arranged between a first mow spindle adjacent to the discharge port and a second mow spindle farther from the discharge port than the first mow spindle, wherein the center baffle is configured to block a direct path of material from the second mow spindle to the discharge port.
